(19) United States
(12) Patent Application Publication
(10) Pub. No.: US 2003/0001846 A1
(43) Pub. Date: Jan. 2, 2003

(54) Automatic personalized media creation system

(76) Inventors: Marc E. Davis, San Francisco, CA (US); Brian F. Williams, San Carlos, CA (US)

Correspondence Address: GLENN PATENT GROUP, 3475 EDISON WAY, SUITE L, MENLO PARK, CA, 94025, US

(21) Appl. No.: 10/169,955

(22) PCT Filed: Jan. 3, 2001
(86) PCT No.: PCT/US01/00106

(30) Foreign Application Priority Data
Jan. 3, 2000 (US) 60174214

(51) Int. Cl. G06T 13/00

(52) U.S. Cl. 345/474

(57) ABSTRACT

An automatic personalized media creation system provides a capture area for a user where the invention elicits a performance from the user using audio and/or video cues and is automatically captured. The video and/or audio of the performance is recorded using a video camera that is automatically adjusted to the user's physical dimensions and position. The performance is analyzed for acceptability and the user is asked to re-perform the desired actions if the performance is unacceptable. The desired footage of the acceptable performance is automatically composited or edited onto pre-recorded and/or dynamic media template footage and is rendered and stored for later delivery. The user selects the media template footage from a set of footage templates. An interactive display area is provided outside of the capture area where the user reviews the rendered footage and specifies the delivery medium.

### BACKGROUND OF THE INVENTION

1. Technical Field

The invention relates to the automatic creation and processing of media in a computer environment. More particularly, the invention relates to automatically creating and processing user specific media and advertising in a computer environment.

2. Description of the Prior Art

The manufacturing of physical goods has undergone three major phases in the last 250 years. Before the Industrial Revolution, all goods were handcrafted in a process of customized production. Skilled craftspeople would toil to make one singular artifact, for example, an exquisitely carved walking stick with an eagle for a handle.

With the Industrial Revolution, the invention of the processes of mass production enabled machines to reproduce the same artifact, once it had been designed by skilled craftspeople, many times over. For example, the exquisitely carved walking stick with an eagle for a handle could be mass produced and therefore sold more cheaply to a wider market of consumers. While mass production brought with it incredible benefits, especially in the reduction of the time and labor needed to manufacture a product, it lost the very real benefit of the creation of a customized product that could meet the specific needs and desires of an individual consumer.

Recent years have seen the beginning of the third phase of the manufacturing of physical goods: mass customization. With mass customization, the efficiencies of mass production are combined with the individual personalization and customization of products made possible in customized production. For example, mass customization makes it possible for individual consumers to order an exquisitely carved walking stick with an eagle for a handle, or a bear, or any other animal and in the length, material, and finish they desire, yet manufactured by machines at a fraction of the cost of having skilled craftspeople carve each walking stick for each individual consumer.

The current state of the art of the production and distribution of media is still largely a craft process. Today very skilled craftspeople use customized production to make one unique media production, e.g., a commercial, music video, or movie trailer, which is then distributed to consumers using techniques of mass production, i e., mass producing the same DVD or CD or broadcasting the same signal to every consumer. There is no current commercial technology for the mass customization of media.

While targeting is a standard part of Web advertising technology, personalization is just beginning to appear. Some companies are inserting a consumer's name into the text and audio tracks of a streaming ad and claim to have response rates up to 150 percent above non-personalized ads. But a truly personalized solution for rich-media Web advertising that utilizes technology for the automatic customization and personalization of media has yet to appear.

Automatic personalized media combine the emotional power and enduring relevance of personal media (amateur photography and video) with the appeal and production values of popular media (television and movies) to create “participatory media” that can successfully blur the distinction between advertising and entertainment. With participatory media, consumers associate the loyalty they feel to their loved ones with the brands and products featured in personalized advertising. For example, consumer's “home movies” will include Nike commercials in which they (or their children) win the Olympic sprinting competition.

Presently, in order to create quality videos or movies, it is necessary to have trained personnel operating the recording equipment, e.g., cameras, lights, etc., direct the actors, and then edit the recorded and other media assets. There is no equivalent of an automated photo booth for video or movies.

The automated photo booth automated the production of a photograph of the user. However, it does so without automating the direction of the user or the cinematography of the recording apparatus, thereby not ensuring a desired result.

Successors exist to the automated photo booth concept that improve upon it in several ways. Photosticker kiosks, already a popular phenomenon in Asia, are also gaining in popularity in the US. Photosticker kiosks often superimpose a thematic frame over the captured photo of the guest and output a sheet of peel-off stickers as opposed to a simple sheet of photos.

Photerra in Florida, produces a photo booth that uploads the captured photo of the guest for sharing on the Internet. AvatarMe produces a photo booth that takes a still image of a guest and then maps the image onto a 3D model that is animated in a 3D virtual environment. The use of 3D models and virtual environments is used mostly in the videogame industry, although some applications in retail clothing booths that create a virtual model of the consumer are appearing.

Additionally, there are also a number of larger, manually operated, guest capture attractions at major theme parks. Colorvision International, Inc., headquartered in Orlando, Fla., provides a manually operated service for producing digitally altered imaging that incorporates the guest's face into a magazine cover, Hollywood-style poster, or other merchandise. Disney's MGM Studios in Orlando, Fla., has an attraction where individuals selected from the audience get up on a stage with a television studio crew, are directed to do a small performance, and then see themselves inserted into a television episode. Similarly, Superstar Studios, a manually operated attraction at Great America, in Santa Clara, Calif., allows guests to buy a music video with themselves performing in it. Finally, there is a manually operated mail-in service offered by Kideo in New York, that takes a still photo of a child and inserts it into a video. In the videos, an animated body of a generic child will move around with the face of the specific child attached to it.

In order to enable a personalized media and advertising business based on captured video, stills, and/or audio of consumers, it is necessary to capture video, stills, and/or audio of consumers that can be repurposed. Due to the variability of the home recording environment and to the low quality of home video cameras, currently, and for the foreseeable future, home capture of video, stills, and/or audio will not be effective for this purpose.

It would be advantageous to provide an automatic personalized media creation system that allows for the automatic video capture of a user and creation of personalized media, video, merchandise, and advertising. It would further be advantageous to provide an automatic personalized media creation system that allows the same user video to be re-used, and reconfigured for use, in multiple video and still titles, as well as for merchandise.

### SUMMARY OF THE INVENTION

The invention provides an automatic personalized media creation system. The system allows for the automatic video capture of a user and creation of personalized media, video, merchandise, and advertising. In addition, the invention provides a system that allows the same user video to be re-used, and reconfigured for use, in multiple video and still titles, as well as for merchandise.

The invention provides a process for automatically creating personalized media by providing a capture area for a user where the invention elicits a performance from the user using audio and/or video cues. The performance is automatically captured and the video and/or audio of the performance is recorded using a video camera that is automatically adjusted to the user's physical dimensions and position.

The invention recognizes the presence of a user and/or a particular user and interacts with the user to elicit a useable performance. The performance is analyzed for acceptability and the user is asked to re-perform the desired actions if the performance is unacceptable.

The desired footage of the acceptable performance is automatically composited and/or edited into pre-recorded and/or dynamic media template footage. The resulting footage is rendered and stored for later delivery. The user selects the media template footage from a set of footage templates that typically represent ads or other promotional media such as movie trailers or music videos.

An interactive display area is provided outside of the capture area where the user reviews the rendered footage and specifies the delivery medium.

In another preferred embodiment of the invention, capture areas are connected to a network where video content is stored in a central data storage area. Raw video captures are stored in the central data storage area. A network of processing servers process raw video captures with media templates to generate rendered movies. The rendered movies are stored in the central data storage area.

A data management server maintains an index associating raw video data and user information, and manages the uploading of rendered and raw content to the registration/viewing computers or off-site hosts. The video is displayed to the user through the registration/viewing computers or Web sites.

Additionally, the invention automatically generates visual and/or auditory user IDs for messaging services. The captured video, stills, and/or audio are parsed to create a, or a set of, representation(s) of the user which are stored in the central data storage area. Whenever another user receives an email or message from the user, the invention retrieves the user's appropriate ID representation stored in the central data storage area. There may be different ID representations depending on the communication, e.g., still picture for email, video for chat.

A secure, dynamic, URL is also provided that encodes information about the user wishing to transmit the URL, the underlying resource referenced, the desired target user or users, and a set of privileges or permissions the user wishes to grant the target user(s). The dynamic URL can be transferred by any number of methods (digital or otherwise) to any number of parties, some of whom may not or cannot be known beforehand.

The dynamic URL assists the invention in tracking consumer viewership of advertising and marketing materials.

Other aspects and advantages of the invention will become apparent from the following detailed description in combination with the accompanying drawings, illustrating, by way of example, the principles of the invention.

### BRIEF DESCRIPTION OF THE DRAWINGS

FIG. 1 is a block schematic diagram of a preferred embodiment of the invention showing the Movie Booth process and creation and distribution of personalized media according to the invention;

FIG. 2 is a diagram of a Movie Booth according to the invention;

FIG. 3 is a block schematic diagram of a networked preferred embodiment of the invention according to the invention;

FIG. 4 is a block schematic diagram of the Movie Booth user interaction process according to the invention;

FIG. 5 is a block schematic diagram of the performance elicitation and recording process according to the invention;

FIG. 6 is a block schematic diagram of the performance elicitation process according to the invention;

FIG. 7 is a block schematic diagram showing the autoframing and compositing process according to the invention;

FIG. 8 is a block schematic diagram showing the auto-relighting and compositing process according to the invention;

FIG. 9 is a block schematic diagram of the personalized ad media process according to the invention;

FIG. 10 is a block schematic diagram of the personalized ad media process according to the invention;

FIG. 11 is a block schematic diagram of the online personalized ad and products process according to the invention;

FIG. 12 is a block schematic diagram showing the personalized media identification process according to the invention;

FIG. 13 is a block schematic diagram showing the personalized media identification process according to the invention;

FIG. 14 is a block schematic diagram of the universal resource locator (URL) security process according to the invention;

FIG. 15 is a block schematic diagram of the universal resource locator (URL) security process according to the invention;

FIG. 16 is a block schematic diagram of the ad metrics tracking process according to the invention; and

FIG. 17 is a block schematic diagram of the ad metrics tracking process according to the invention.

### DETAILED DESCRIPTION OF THE INVENTION

The invention is embodied in an automatic personalized media creation system in a computer environment. A system according to the invention allows for the automatic video capture of a user and creation of personalized media, video, merchandise, and advertising. In addition, the invention provides a system that allows the same user video to be re-used, and reconfigured for use, in multiple video and still titles, as well as for merchandise.

The invention's media assets are reusable, i.e., the same guest video can be reused, and reconfigured for use, in multiple video, audio, and still titles, as well as for merchandise. On the capture side, the invention provides the technology to make guest video captures reusable by separating the guest from the background she is standing in front of, automatically directing the guest to perform a reusable action, and automatically analyzing and classifying the content of the captured video of the guest.

The invention makes possible the mass customization and personalization of media. The technology for the mass customization and personalization of media supports new products and services that would be infeasible due to time and labor costs without the technology. By automating and personalizing the key media production processes of direction, cinematography, and editing, the invention enables automatic personalized media products that incorporate video, audio, and stills of consumers and their friends and families in media used for communication, entertainment, marketing, advertising, and promotion. Examples include, but are not limited to: personalized video greeting cards; personalized video postcards; personalized commercials; personalized movie trailers; and personalized music videos.

While targeting is a standard part of Web advertising technology, personalization is just beginning to appear. Some companies are inserting a consumer's name into the text and audio tracks of a streaming ad and claim to have response rates up to 150 percent above non-personalized ads. The invention makes possible the delivery of personalized advertising that automatically incorporates reusable video, audio, and stills of consumers, their friends, and their family, directly into personalized and shareable advertising content deliverable on the Web and on other digital media distribution platforms.

With the invention, advertisers can not only target their messages to consumers, but more potently, appeal directly to consumers with truly personalized video messages featuring consumers and their friends and families. Without the invention, the cost of creating personalized rich media advertising for consumers would be prohibitively expensive. Hollywood studios and Madison Avenue ad agencies make single titles which millions of people watch. The invention enables the creation of automatic personalized media and advertising that an unlimited number of people can appear in, watch, and share. This new category of personalized content will deliver on the promise of media-rich, one-to-one marketing, advertising, and entertainment on the Web and on all digital media distribution platforms.

Automatic personalized media combine the emotional power and enduring relevance of personal media, e.g., amateur photography and video, with the appeal and production values of popular media, e.g., television and movies, to create participatory media that can successfully blur the distinction between advertising and entertainment. With participatory media, consumers associate the loyalty they feel to their loved ones with the brands and products featured in personalized advertising. For example, consumers home movies will include Nike commercials in which they or their children win the Olympic sprinting competition.

The prior art described above differs from the invention in three key areas: automation of all aspects of capture, processing, and delivery of personalized media; the use of video; and the reuse of captured assets. The invention is embodied in a system for creating and distributing automatic personalized media utilizing automatic video capture, including automatic direction and automatic cinematography, and automatic media processing, including automatic editing and automatic delivery of personalized media and advertising whether over digital or physical distribution systems. In addition, the invention enables the automatic reuse of captured video assets in new personalized media productions. Each of these inventions—automatic capture, automatic processing, automatic delivery, and automatic reuse—can be used separately or in conjunction to form a total end-to-end solution for the creation and distribution of automatic personalized media and advertising.

Presently, no other company automatically directs the guest, automatically controls the cinematographic apparatus, automatically edits the personalized media, automatically reuses the guest video in new personalized media, and automatically delivers sharable automatic personalized media and advertising.

### Automatic Capture and Processing

Creating an automatic capture system requires the ability to adjust to the physical specifics of the person being captured. To automatically capture reusable video of a user, it is necessary to elicit actions that are of a desired type. Additionally, an automatic capture system must adjust its recording apparatus to properly frame and light the guest being captured.

Human directors work with actors and non-actors to elicit a desired performance of an action. A director begins by instructing a person to perform an action, she then evaluates that performance for its appropriateness and then, if necessary, reinstructs the person to re-perform the action—often with additional instructions to help the person perform the action correctly. The process is repeated until the desired action is performed. Each performance is called a take and current motion picture production often involves many takes to get a desired shot.

The invention automates the function of a director in instructing a user, eliciting the performance of an action, evaluating the performance, and then, if necessary, re-instructing the user to get the desired action. While the central application of this invention is in the automatic creation of personalized media, specifically motion pictures, the approach of automatic direction can be applied in any situation in which one wishes to automate human-machine interaction to elicit, and optionally record, a desired performance by the user of a specific action or an instance of a class of desired actions. The invention also automates the function of a cinematographer in automatically framing and lighting the guest while she is being captured, and can also “fix in post” many common problems of framing and lighting.

During the editing process, when combining video and/or images captured from different sources, it is necessary to adjust the captured footage to comply with the constraints of the desired output and often vice versa as well. A common technique in the creation of motion pictures is to capture/synthesize a background layer and various foreground layers at different times and composite the foreground layers over the background layer after the fact. The process of preparing the various layers for compositing is today a labor intensive and skilled manual process involving reframing, relighting, and motion matching assets. The automation of the process of preparing recorded footage for compositing is required for a fully functional “automatic editing” system that seeks to automate motion picture postproduction processes for automatic personalized media products and services, and can also be used in the service of other more traditional postproduction projects.

The invention allows the system to automatically change the framing of the original input so that more or less of the recorded subject appears or the recorded subject appears in a different position relative to the frame. The system can also automatically change the lighting of the recorded subject in a layer so that it matches the lighting requirements of the composited scene. Additionally, the system can automatically change the motion of the recorded subject in a layer so that it matches the motion requirements of the composited scene.

### Automatic Movie Booth

The invention comprises:

a) A Movie Booth or kiosk or open capture area (an enclosed, partially enclosed, or non-enclosed capture area of some kind for the user).

b) System for automatic direction, automatic cinematography, and automatic editing.

c) Distribution/display of automatically produced, personalized media product.

The Movie Booth consists of:

a) Capture area for customer (“Movie Booth”).

b) Capture devices (video camera and microphones).

c) Computer hardware (co-located or remote).

d) Software system (co-located or remote).

e) Network connection (optional).

f) Equipment for writing a movie to fixed media or other personalized merchandise and dispensing the fixed media or other personalized merchandise (optional).

g) Display devices (co-located or remote)

The automatic personalized media creation system elicits a certain performance or performances from user. Eliciting a performance from the user can take a variety of forms:

Record Unstructured Activity

This is the process of recording without knowing what the user is doing in advance and without trying to structure what the user is doing.

Record Structured Activity

Record the user engaged in an activity whose structure the system knows enough about in order to parse it and process it automatically. An example is recording the user playing a videogame.

Directed Performance

The user is directed to perform a specific action or a line in response to another user, and/or a computer-based character, and/or in isolation where a specific result is desired.

Improvised Performance

The user is asked to improvise an action or a line in response to another user, and/or a computer-based character, and/or in isolation in which the result can have a wide degree of variability (e.g., act weird, make a funny sound, etc.).

Agit Prop

The user produces a reaction in response to a system-provided stimulus: e.g., system yells “Boo!”→user utters a startled scream.

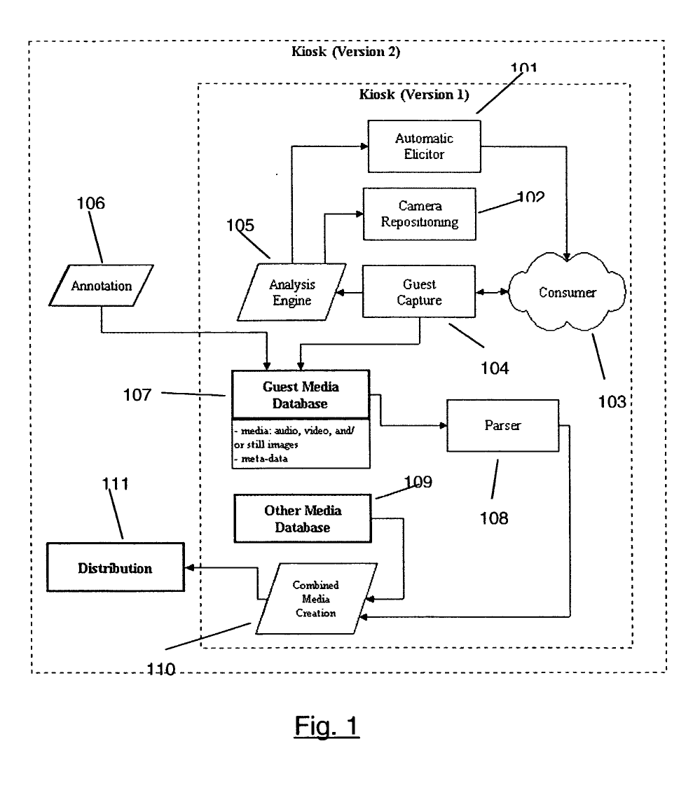

Referring to FIG. 1, the mechanism for eliciting a performance from the user is called the Automatic Elicitor 101. A preferred embodiment of the invention's Automatic Elicitor 101 elicits a performance from the user 103 through a display monitor(s) and/or audio speaker(s) that asks the user 103 to push a touch-screen or button or say the name of the title in order to select a title to appear in and begin recording. Upon touching the screen or button or saying the name of the title, the system interacts with the user 103 to elicit a useable performance.

In another embodiment of the invention, the system recognizes the presence of a user and/or a particular user (done by motion analysis, color difference detection, face recognition, speech pattern analysis, fingerprint recognition, retinal scan, or other means) and then interacts with the user to elicit a useable performance.

Video and audio is captured 104 using a video or movie camera. If the camera needs to be repositioned 102, this is performed by using, but is not limited to, eye-tracking software. Such commercially available software allows the system to know where the eyes of the user are. Based on this information, and/or information about the location of the top of the head (and size of the head), the system positions the camera according to predefined specifications of the desired location of the head relative to the frame and also the amount of frame to be filled by the head. The camera and/or lens can be positioned using a robotic controller.

The user is elicited to perform actions by the Automatic Elicitor 101. The user's performance is analyzed in real or near real-time and evaluated for its appropriateness by the Analysis Engine 105. If new footage is required, the user can be re-elicited, with or without information about how to improve the performance, by the Automatic Elicitor 101 to re-perform the action.

Acceptable video and/or audio, once captured, is then transferred to a Guest Media Database 107. Once the footage is in the Guest Media Database 107, it can be combined by the Combined Media Creation module 110 with an existing pre-recorded or dynamic template stored in the Other Media Database 109. Additional information can be added through the Annotation module 106.

An example of the process is the creation of a movie of a person standing on a beach, waving at the camera. The system asks the person to stand in position and wave. Once the capture is completed, the system analyzes the captured footage for motion (of the hand) and selects those frames that include the person waving his hand. This footage is then composited into pre-recorded footage of a beach scene.

In another embodiment of the invention, the captured footage of the person in the above example, can be edited into (as opposed to composited into) the pre-recorded beach scene.

The resulting video is then rendered by the Combined Media Creation module 110. Once the video is completed, it can be transferred to fixed media such as VHS tape, CD-ROM, DVD, or any other form now known or to be invented. Such fixed media can then be distributed 111 through the Movie Booth, at the site of the Movie Booth, or can be created at another location (by transferring the movie file) and produced and distributed through other means (retail outlets, mail order, etc.).

Distribution 111 can also take the form of broadcast or Web delivery, through streaming video and/or download, and DBS. When delivering the output to traditional analog and digital fixed media, the rendered format will typically be a standard such as NTSC or PAL for the analog domain, or MPEG1 (for VideoCDs) or MPEG2 (for DVDs) for the digital domain. When delivering output digitally, the rendered format may actually encode the composition, editing and effects used in the film for recombination at the client viewing system, using a format such as MPEG4 or QuickTime, potentially resulting in storage, processing and transmission efficiencies.

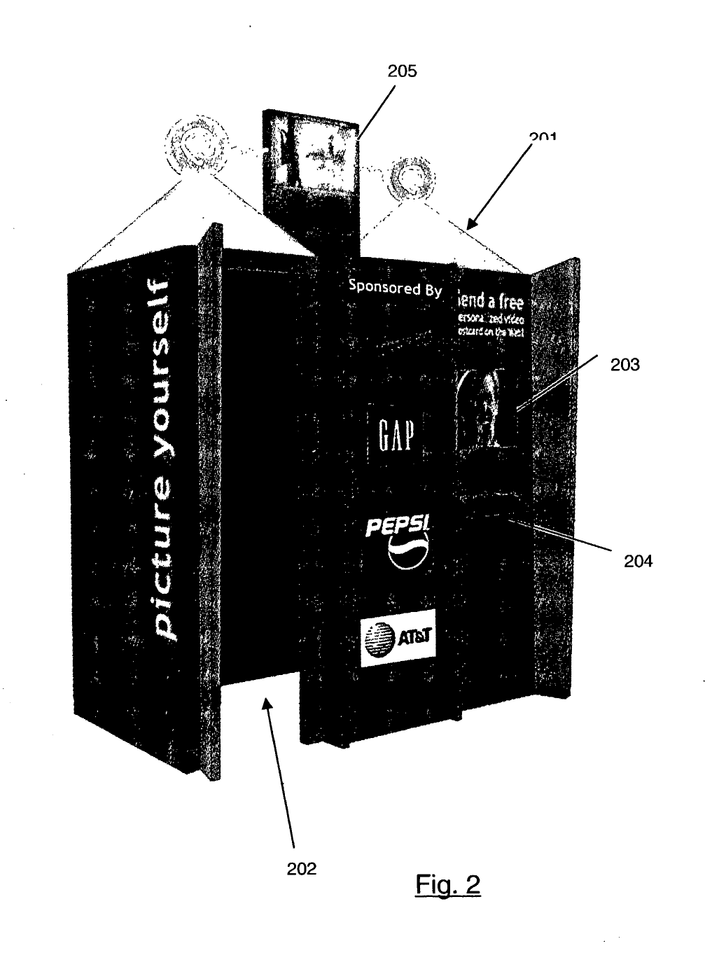

With respect to FIG. 2, the Movie Booth is housed in a structure 201 similar to many existing Photo Booths, Photo Kiosks, or video-conferencing booths. An interior space 202 can be closed off from the outside by a curtain or sliding door, providing some privacy and audio isolation. By using a half-silvered mirror, an interactive visual display can be superimposed in front of the recording camera, providing a virtual director. There are a small number of interior lights, both for lighting of the occupant and directing the occupant's attention. Speakers are situated in key points throughout the capture space to help direct guest attention. All interactions with the guest while inside the Movie Booth are with lights, video, audio, and optionally with one or two buttons.

A separate display 203 is housed on an exterior face of the Movie Booth, with an embedded membrane keyboard 204 below it, where the guest can enter his/her name and e-mail address and optionally friends' e-mail addresses. There is a third monitor 205 on the roof of the Movie Booth, which displays a video loop that attracts consumers.

As noted above, the invention's Movie Booth design has an automatic capture area 202 (where the computer directs the user with onscreen, verbal, lighting cues, and captures and processes video clips) and a registration area 203, 204 (where the user sees the finished product and can enter email and registration information). A high-end PC, equipped with an MJPEG video capture card, MPEG2 encoder, and fast storage handles capture and interaction with the user while inside the Movie Booth.

The registration computer is a relatively modest computer, which must be able to playback video at the desired resolution and frame rate and be able to transmit the captured media back to the server (over a DSL or T1 network connection). Because the registration CPU doesn't need to be performing intensive processing, it can be spooling guest performances to the central server in the background or during inactive hours. The registration computer has sufficient storage to store several days of guest captures in case of network outages, server unavailability or unexpectedly high traffic.

The camera used for capture can be a high resolution, 3 CCD, progressive scan video camera with a zoom lens. In order to support a wide range of guest heights and shots, the camera can be mounted on a one-degree of freedom motor-controlled linear slide or an equivalent. Other camera types can be used in the invention as well.

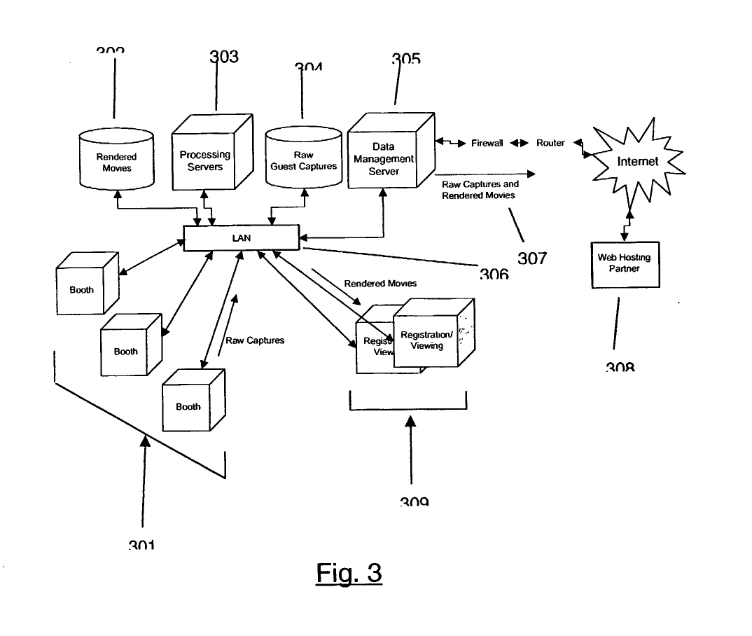

Referring to FIG. 3, a preferred embodiment of the invention consists of a local area network 306 of capture stations 301 (the Movie Booths) connected to data storage 302, 304, processing servers 303, and a data management server 305. The network supports a configurable number of on-site registration and viewing computers 309. In order to support off-site viewing, there is an uplink connection 307 from the venue, which allows uploading of the video content to a centralized datacenter and Web/video hosting location 308.

Raw video captures flow from the booths 301 to a network-attached storage (NAS) device 304, where they are processed by processing servers 303 to generate rendered movies, which are stored on a separate NAS device 302. The NAS containing the rendered movies functions 302 as a primitive file/video server, supporting viewing on any of the registration/viewing computers 309. The data management server 305 maintains an index associating raw video data and user information, and manages the uploading of rendered and raw content to the off-site host 308.

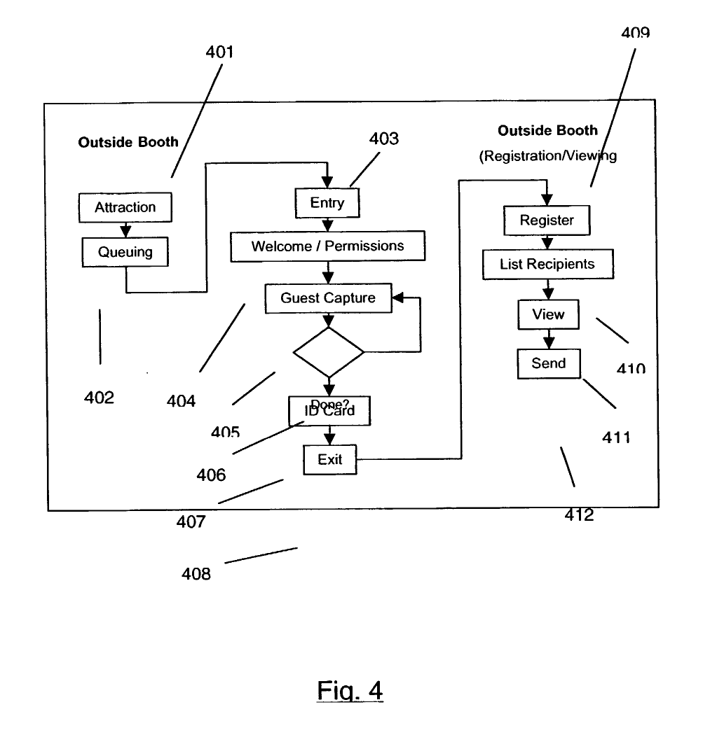

With respect to FIG. 4, the interaction sequence between the invention and the user is shown.

### Attraction 401

Promotional monitor shows teaser footage of capture process and describes the product.

### Queuing 402

Users wait at entrance for occupant to exit for registration.

### Entry 403

Video camera detects entry of user into the Movie Booth.

### Welcome/Permissions 404

An audio/visual greeting invites the user to get comfortable and situated, and describes the simple default permissions policy.

### Title Selection 405

Users see a simple display of potential titles on screen (initially<10, not scrolling) and selects one.

### Guest Capture 406

The user is directed through a sequence of captures, repeating performances if they fail to meet desired specifications (duration, volume, motion, etc.). Capture may eventually timeout if the user is completely uncooperative or the hardware is malfunctioning. System will have a fallback title that will work almost all the time, regardless of user noncompliance.

### ID Card 407

Once the capture is completed, the booth will print out a souvenir ID card with the user's photo, information on how to access his/her movie at the venue and from home, and potentially other marketing information. The ID card can have a PIN number printed on it which ensures that only the holder can get access to his or her personalized movie.

### Exit 408

Users are asked to step outside and go to the registration station.

### Register 409

Users are asked to enter their name, possibly other demographic information such as birthdate and/or sex, and email address.

### List Recipients 410

Users can type in a list, or a preset number, of email addresses of friends to deliver the postcard to.

### View 411

Users get to watch the resulting movie, or a preset amount of times, at broadcast resolution.

### Send 412

Users indicate whether or not to send the video postcard to the recipients.

In order to streamline the experience for the guest, the current guest interaction at the Movie Booth is a two-stage process. Title selection and capture are done inside the Movie Booth, and registration and viewing of the output occur outside the Movie Booth on a second display. Because capture and registration can be active at the same time, the Movie Booth can support interleaved throughput, e.g., with a total per guest interaction time of five minutes per guest, rather than having a max of 12 guests/hour or one every five minutes, it can support 24 guests/hour. The Movie Booth's interleaved two-stage throughput may also be critical in keeping line size manageable, as it makes it difficult for one person to take over the Movie Booth.

While the user transitions from the capture stage to registration, the system can render the output in the background, minimizing the perceived wait time, if any is required. Repeat users will also require less wait time due to a faster registration phase which would be replaced by a login phase. Wait time can also be reduced by reducing the number of shots captured per user visit. The current interaction time budget allocates two minutes per user visit to capture four to five user shots. In high throughput situations the target number of shots to capture can be reduced to lower the overall visit time to two to three minutes.

### Automatic Guest Capture

A preferred embodiment of the invention elicits a specified performance, action, line, or movement from the user.

### General Method

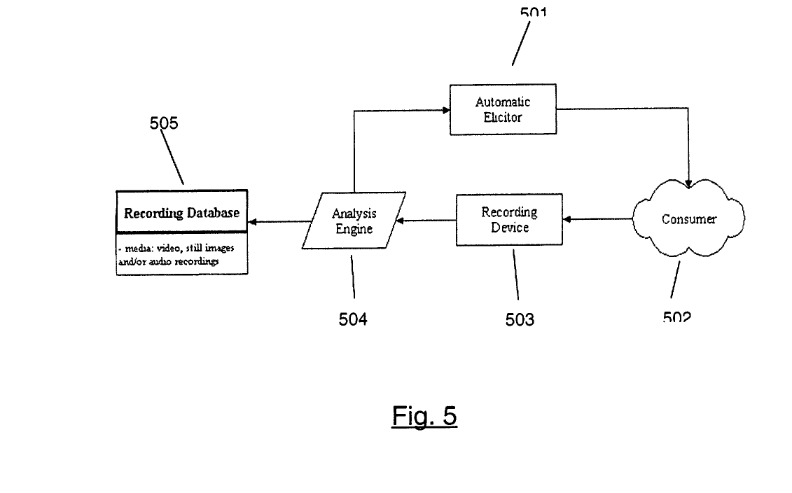

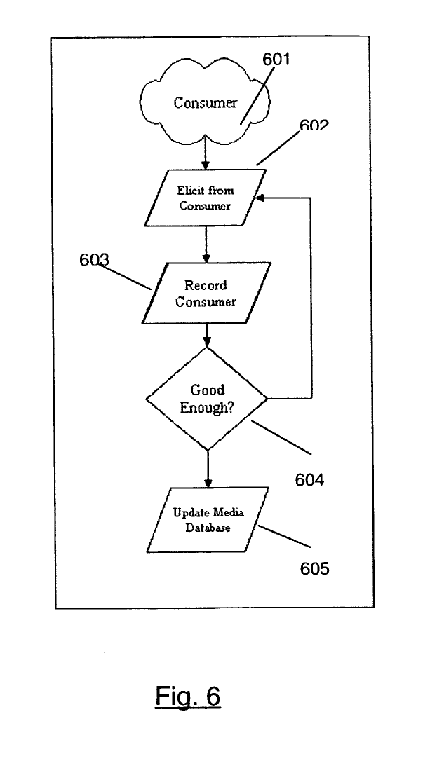

Referring to FIGS. 5 and 6, the invention goes through the process of eliciting a performance 501 from the user 502, recording the performance 503, analyzing the performance 504, and storing the recording 505. The general method is:

1. Eliciting a performance 602 from the user 601.

Eliciting a performance from the user can take a variety of forms:

Record Unstructured Activity

This is the process of recording without knowing what the user is doing in advance and without trying to structure what the user is doing.

Record Structured Activity

Record the user engaged in an activity whose structure the system knows enough about in order to parse it and process it automatically. An example is recording the user playing a videogame.

Directed Performance

The user is directed to perform a specific action or a line in response to another user, and/or a computer-based character, and/or in isolation where a specific result is desired.

Improvised Performance

The user is asked to improvise an action or a line in response to another user, and/or a computer-based character, and/or in isolation in which the result can have a wide degree of variability (e.g., act weird, make a funny sound, etc.).

Agit Prop

The user produces a reaction in response to a system-provided stimulus: e.g., system yells “Boo!”→user utters a startled scream.

2. Capture video and audio (and other streams) 603.

3. Analyze the inputs 604.

4. Try to match the performance against potential performances or criteria for a useable performance in a database to determine whether further direction is needed 602 or if the performance is acceptable 605.

5. If further direction is required, the system prompts user to repeat the action, possibly with additional coaching of the user 602.

6. In the event that the system is evaluating several conditions 604, then the coaching 602 can be based on measurements of performance relative to these conditions. The system can also coach the user to eliminate aspects of performance. For example, the system can check for swearing and even though the performance might be satisfying in other ways, the system prompts for a new performance because it detects a swear word.

7. System repeats 604, 602, 603 until it detects a usable performance or has reached a threshold of attempts and either works with the best of the non-usable performances 605 or in the case of deliberate user misbehavior, e.g., swearing or nudity, may ask the user to cease interaction with system.

### Guest Capture: Interactive Audio Analysis

In the audio domain, this requires a combination of robust interaction techniques to elicit an audio performance, e.g., speech, non-speech audio, singing, etc., with real-time and near real-time analysis of the user's audio performance.

1. The automatic direction system interacts with the user to elicit the desired audio output. This is done in a variety of ways, including the use of: verbal instructions; video instructions; still image instructions; lighting or non-verbal sonic cues; the playing of a game such as a videogame; the presentation of physical stimuli such as a loud noise, a bright flash of light, a funny or scary or emotionally powerful image, sound or video, a strong smell, vibration, or air blast of varying temperatures; etc.

2. The audio analysis is then used to either accept the output as useable or to reject the output and trigger a new cycle of user interaction to elicit a useable performance.

### Guest Capture: Interactive Video Analysis

In the video domain, this requires a combination of robust interaction techniques to elicit a video performance, e.g., facial expressions, gross body movements, gestures, etc., with real-time and near real-time analysis of the user's video performance.

1. The automatic direction system interacts with the guest to elicit the desired video output. This is done in a variety of ways, including the use of: verbal instructions; video instructions; still image instructions; lighting or non-verbal sonic cues; the playing of a game such as a videogame; the presentation of physical stimuli such as a loud noise, a bright flash of light, a funny or scary or emotionally powerful image, sound or video, a strong smell, vibration, or air blast of varying temperatures; etc.

2. The video analysis is then used to either accept the output as useable or to reject the output and trigger a new cycle of user interaction to elicit a useable performance.

### Guest Capture: Interactive Audio and Video Analysis

In the combined audio and video domain, this requires a combination of robust interaction techniques to elicit an audio and video performance, e.g., yell and punch, dance and sing, wave and talk, etc., with real-time and near real-time analysis of the user's audio and video performance. In addition, audio and video analysis techniques can be used to analyze a performance for crossmodal verification even when the desired performance is in a single mode, e.g., the clap events of video of hand clapping can be analyzed by listening to the audio, even though only the video of the hand clapping may be used in the output video with new foleyed audio synchronized with the video clap events.

1. The automatic direction system interacts with the user to elicit the desired audio and video output. This is done in a variety of ways, including the use of: verbal instructions; video instructions; still image instructions; lighting or non-verbal sonic cues; the playing of a game such as a videogame; the presentation of physical stimuli such as a loud noise, a bright flash of light, a funny or scary or emotionally powerful image, sound or video, a strong smell, vibration, or air blast of varying temperatures; etc.

2. The audio and video analysis is then used to either accept the output as useable or to reject the output and trigger a new cycle of user interaction to elicit a useable performance.

### Specific Shot Methods

### Looking at the Camera Shot

1. A recording (video and/or audio) directs the user to stand still and look at the camera.

2. The video of the user is analyzed to determine eye location frame b y frame.

3. If both eyes are visible, and the user's position is not changing significantly between frames, the system assumes that the user has stopped moving and is looking at the camera.

4. If the eyes do not stop moving, the user is prompted again to stand still and look at the camera.

### Scream Shot

1. A recording, video and/or audio, directs the user to scream.

2. The result is analyzed for duration and volume—or other analytical variables such as: presence of speech in user utterance; presence of undesirable keywords in user utterance; pitch or pitch pattern; volume envelope; energy, etc.

3. If the user's scream does not meet the desired thresholds of the desired criteria, the system prompts again, letting the user know to scream longer, louder, or as needed to meet the desired criteria, as necessary.

### Head Turn Shot

1. A recording, video and/or audio, directs the user to stand at an angle to the camera and look straight ahead and then turn to look at the camera.

2. System analyzes resulting video and determines the presence and position of the user's eyes—calculating the amount of motion of the user.

System begins by detecting an absence of motion and the lack of eyes (since user is in profile and only one eye is visible). Upon starting the action, system detects motion of the head, and eventually locates both eyes as they swing into view. The completion of the action is detected when the eyes stop moving and the motion of the head drops below a threshold.

3. Each portion of the action may have a maximum duration to wait and if a transition to the next stage does not occur within this time limit, system prompts the user to start again, with information about which portion of the performance was unsatisfactory or other instructions designed to elicit the desired performance.

### Automatic Pre-Capture Adjustment

The invention is an interactive system that controls its own recording equipment to automatically adjust to a unique user's size (height and width) and position (also depth). The system is a subsystem of a general automatic cinematography system that can also automatically control the lighting equipment used to light the user. The system can also be used with the automatic direction system to elicit actions from the user that may enable him or her to accommodate to the cinematographic recording equipment. In the video domain, this may entail eliciting the user to move forward or backward, to the right or left, or to step on a riser in order to be framed properly by the camera. In the audio domain, this may entail eliciting the user to speak louder or softer.

### Automatic Pre-Capture Adjustment: AutoFraming

The invention captures and analyzes video of the user using a facial detection and feature analysis algorithm to locate the eyes and, optionally, the top of head. The width of the face can either be determined by using standard assumptions based on interocular distance or by direct analysis of video of the user's face.

Using the analyzed information about the position of key facial features (especially eye positions) a computer actuates a motor control system, such as a computer-controlled linear slide and/or computer-controlled pan-tilt head and/or computer-controlled zoom lens, to adjust the recording equipment's settings so as to view the user's face in the desired portion of the frame. In addition to applications in Movie Booths, the technique of automatic pre-capture adjustment autoframing can have application to still and video cameras that would be able to autoframe their subjects.

### Automatic Post-Capture Adjustment

A preferred embodiment of the invention automates three key aspects of preparing recorded assets for compositing: reframing the recorded subject—involving keying the subject and then some combination of cropping, scaling, rotating, or otherwise transforming the subject—to fit the compositional requirements of the composited scene; relighting the recorded subject to match the lighting requirements of the composited scene; and motion matching the recorded subject to match any possible motion requirements of the composited scene. The described techniques of the invention can also be used for modifying captured video or stills without compositing. An example here would be digital postproduction autoframing of a human subject's face in a still photo, which would have wide application in consumer still and video photography.

### Automatic Post-Capture Adjustment: AutoFraming

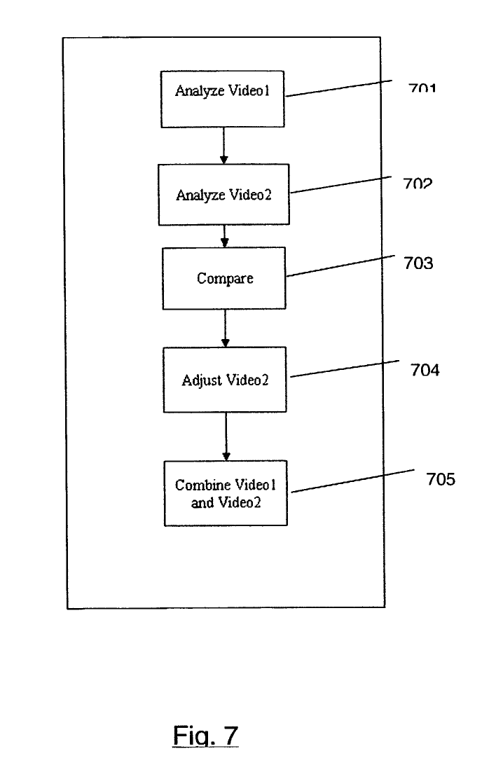

With respect to FIG. 7, the invention creates a model of the person in the captured video and, using digital scaling and compositing, places the person into the shot with the desired size and position. This technique can also be used to reframe captured footage without using it for compositing.

1. The invention analyzes the video to find the eyes 701.

2. System extracts the foreground 701, using a technique such as chromakeying. By calculating the width of the foreground object at eye level, system gets an approximation of the head width. The distance between the eyes is also a fairly good indicator of head size, assuming the person is looking at the camera. The system assumes the person is level and finds the top of the head by looking for the foreground edge above the eyes. The system might also look for other facial features to determine head size and position, including but not limited to ears, nose, lips, chin and skin, using techniques such as edge-detection, pattern-matching, color analysis, etc.

3. Repeat this process for each input frame.

4. In order to create the output shot, based on the desired shot framing, the system chooses a desired head width and eye position in shot template 702, 703, which again might vary frame by frame.

5. Using digital scaling 704, the system composites the foreground into the shot template 705.

### Automatic Post-Capture Adjustment: Simple Auto-Relighting

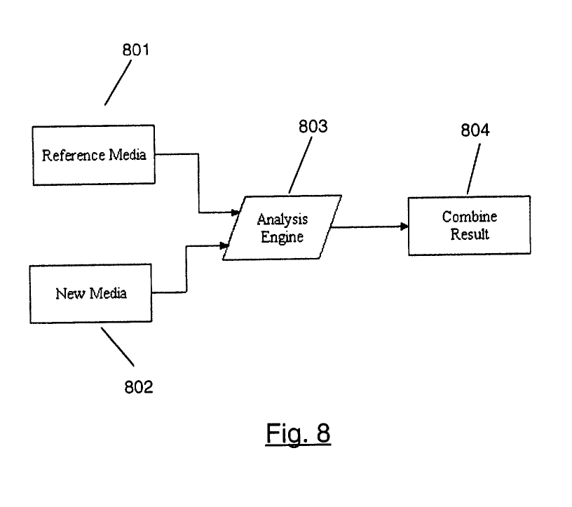

Referring to FIG. 8, the invention creates a simple reference light field model of the lighting in the captured video by using frame samples from the captured video and applies a transformation to the light field to match it to the desired final lighting. This technique can also be used to relight captured footage without using it for compositing.

1. The invention captures the foreground 802 with a uniform, flat lighting.

2. System extracts changes in light from the background of the destination video 801 by identifying a region of interest with minimal object or camera motion and comparing consecutive frames of the captured video. The system can also extract an absolute notion of light by choosing a reference frame and region of interest from the destination video and comparing each frame of the captured video with the reference frame's region of interest. The region of interest should overlap the final destination of the foreground of the captured video, or the algorithm will have no effect.

3. Each comparison 803 generates a light field, which can be smoothed or modified through various functions based on the desired final scene lighting.

4. When performing the composite, the smoothed light field is used as an additional layer on top of the foreground and background. The light field is combined with the bottom two layers in a manner to simulate the application or removal of light 804.

### Automatic Post-Capture Adjustment: Automotion Match

Referring again to FIG. 7, general description of solution: automatically identify a feature on the recorded subject to track in order to derive the subject's motion path, and transform the motion path to match the subject's motion to a desired motion path in the composited scene. This technique can also be used to change the motion path of captured footage without using it for compositing.

1. The invention automatically identifies and then tracks the position of a key feature in the recorded subject to derive the subject's motion path 702, such features include but are not limited to: eye position; top of head; or center of mass.

2. System transforms the motion path 703 of the recorded subject 702 to match the motion path of a desired element in, or elements in, or the entire, composited scene 701. The system may also use the motion path 703 of the recorded subject 702 to transform the motion path of a desired element in, or elements in, or the entire, composited scene 701. In addition, the system may also co-modify the motion path 703 of the recorded subject 702 and the motion path of a desired element in, or elements in, or the entire, composited scene 701. Examples of motion paths to match and/or modify include but are not limited to: the motion path of a car the subject is composted into; the motion of the entire scene in an earthquake; and eliminating or dampening the motion of the subject to make them appear steady in the scene.

3. Apply the transformed motion path to the recorded subject 704 to match the motion path of a desired element in, or elements in, or the entire, composited scene (or vice versa or co-modify the motion paths).

4. Composite the layers together 705.

### Personalized Advertising

The current dominant paradigms of advertising consist of either a) interruption, or b) product placement. Interruption can be seen in most television ads, where commercials interrupt the programs. Product placement consists of inserting a product into a program so that the viewer is exposed to the product. The advertiser's hope is that if the viewer identifies with the characters and their world, they will identify with the products they use.

However, interruption advertising is essentially hostile to its viewers who often react by trying to avoid it. Additionally, product placement tends to be subliminal and it is hard to measure its effectiveness. It is desirable to create a method of advertising that is as compelling as other, non-advertising content. The invention allows the creation and delivery of advertising that automatically includes captured video, stills, and/or audio of the consumer and/or their friends and family.

The invention revolutionizes advertising and direct marketing by offering personalized media and ads that automatically incorporate video of consumers and their friends and families. Personalized advertising has a unique value to offer advertisers and businesses on the Web and on all other digital media delivery platforms—the ability to appeal directly to customers with video, audio, and images of themselves and their friends and family.

The advertising guru David Ogilvy said: “Get the consumer in the headline.” Personalized advertising makes that literally true. Imagine FTD being able to entice you to buy flowers in a banner ad featuring you and your loved one; or teenagers being able to appear in streaming video Gap commercials that they can share and vote on; or watching the Super Bowl and seeing you and your buddies appear in the Budweiser “Wassup?” ad. These scenarios and more are possible with the power of personalized advertising.

Personalized advertising has the following significant advantages over non-personalized advertising and marketing:

Consumers will pay attention to ads and watch them multiple times because they and their friends and family are in them, i.e., personalized advertising, by varying the inserted guest, has built in frequency.

Consumers will personally relate to and identify with brands because they will literally see themselves in the brand.

And by combining the reach of email with the power of streaming media, consumers will be able to share their personalized ads and media with friends and family. So for every consumer advertisers reach with a personalized ad, they reach all the people the consumer shares it with.

Additionally, the Internet advertising market is a large and growing market in which the leading advertising solutions, banner ads, have been steadily losing their effectiveness. Internet viewers are paying less attention and clicking through less. By automatically delivering personalized banner ads featuring consumers and/or their friends and families, the invention improves the effectiveness of banner ads and other advertising forms, such as interstitials and full motion video ads and direct marketing emails, at gaining viewer attention and mindshare.

Furthermore, banner ads have tended to be delivered as single animated gif images in which targeting affects the selection of an entire banner as opposed to the invention's on-the-fly, custom assembly of a banner from individual ad parts. The invention's customized dynamic rich media banner ads take targeted banners further by assembling media rich banners (images, sound, video, interaction scripts) out of parts and doing so based on consumer targeting data.

Advertisers, and clients of advertisers, are currently struggling to provide accurate metrics of advertising viewership. Current solutions include measuring the number of people who dick on a Web page or on an advertising link. As advertising becomes more entertaining and personally relevant, it is desirable to provide mechanisms for consumers to share advertising they enjoy—and to track this sharing; the invention provides such a mechanism. A preferred embodiment of the invention provides the delivery of advertising

that automatically includes captured video, stills, and/or audio of consumers and/or consumers' friends and family in it. Another embodiment of the invention automatically personalizes and customizes physical promotional media (T-shirts, posters, etc.) that include the user's imagery and/or video. Yet another embodiment of the invention automatically personalizes and customizes existing media products (books, videos, CDs) by combining captured video, stills, and/or audio with captured video, stills, and/or audio from, or appropriate to, the products and bundling the customized merchandise with the existing merchandise. The database is designed to allow users to select among different captured video, stills, and/or audio of themselves and/or their friends and family.

### Automatic Personalized Media and Advertising

A preferred embodiment of the invention provides a new and improved process for capturing, processing, delivering, and repurposing consumer video, stills, and/or audio for personalized media and advertising. The system uses:

a) Out-of-home video, still, and/or audio capture devices.

b) Technology for processing and reusing the captured video, stills, and/or audio.

c) Delivery of customized/personalized media products and/or advertisements.

### Out-Of-Home Video, Still, and/or Audio Capture Devices

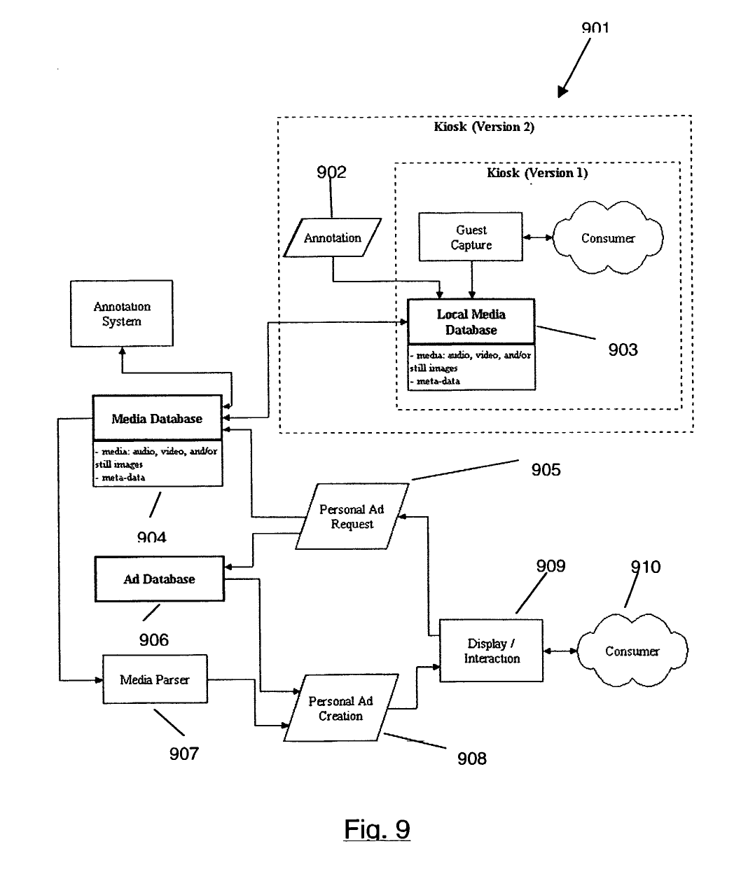

With respect to FIG. 9, video, stills, and/or audio are captured outside of the home environment, under controlled conditions 901. These conditions can include but are not limited to an automated photo or video booth/kiosks, a ride capture system, a professional studio, or a human roving photographer. The invention does not require that the video, stills, and/or audio be captured out-of-home; out-of-home capture is simply currently the best mode for capturing reusable video, stills, and/or audio of consumers.

Metadata 903, such as user name, age, email address, etc., associated with the captured video, stills, and/or audio can be gathered at the time of capture. In one embodiment of the invention, the data can be gathered by having the user provide it by entering it into a machine or giving it to an attendant. Such video, stills, and/or audio, once captured, are then transferred to a database 903.

### Video, Stills, and/or Audio Reuse

### Database of User Video, Stills, and/or Audio

The video, stills, and/or audio database 904 is a collection of video, stills, and/or audio that includes metadata about the video, stills, and/or audio. This metadata could include, but is not limited to, information about the user: name, age, gender, email, address, etc.

### Identifying Video, Stills, and/or Audio With Appropriate Metadata

In one form of the process, the video, stills, and/or audio are annotated manually. Theme park guests, for example, can type in their names at the time the video, stills, and/or audio of them is captured. The system then correlates the name they supply with the video, stills, and/or audio captured.

Once the video, stills, and/or audio are finalized, they are sent to the main database 904. The user browses through a list of ads in the ad database 906 and selects the ad that she likes 905. The ad is then created 908 by combining the user's video, stills, and/or audio extracted from the user's material 907 in the database 904 with the ad selected by the user from the ad database 906. The resulting ad is displayed to the user 909 and later delivered as the user selected 910.

### Parsing Appropriate Video, Stills, and/or Audio

If the video, stills, and/or audio in the database are in the form of video, it is necessary for there to be a procedure for parsing the video to extract the appropriate video, stills, and/or audio segment. Similarly, stills and audio can also be subject to parsing for segmentation. Such a system would, though need not be limited to:

1. The system examines a sequence of video, captured of a single user.

2. Using existing, commercially available eye-detection software, the system analyzes the video and determines the location of the users eyes.

3. The system determines when the head is framed within the shot and the eyes are facing forward. If the video is captured under conditions where background information is available to the system, the system is able to determine the shape and location of the head by tracking out from the eyes until it detects the known background. If the video is captured under conditions where the background information is not available to the system, the system could determine the location of the eyes and then determine the size of the head based on, among other methods, a) the dimensions of the distance between the eyes, b) an analysis of skin color, c) analyzing a sequence of frames and determining the background based on head motion. If the system is unable to find a frame in which the head is fully visible, the system accepts frames in which the eyes are facing forward (or best match). Additional parsing criteria could be employed to further select frames in which desired facial expressions are apparent, e.g., smile, frown, look of surprise, anger, etc., or a sequence of frames in which a desired expression occurs over time, e.g., smiling, frowning, being of surprised, getting angry, etc.

4. If there are several frames that match the criteria above, the system analyzes changes between frames to determine which two frames have the least amount of head movement.

In another embodiment of the invention, the system automatically analyzes and extracts a series of frames to provide a brief animation and/or video sequence.

In yet another embodiment of the invention, the desired content is parsed based on audio criteria to select a target utterance, e.g., “Are you ready?”. Further instantiations could parse user performance to select a desired combined audio/video utterance, e.g., bouncing head while singing “The Joy of Cola.”

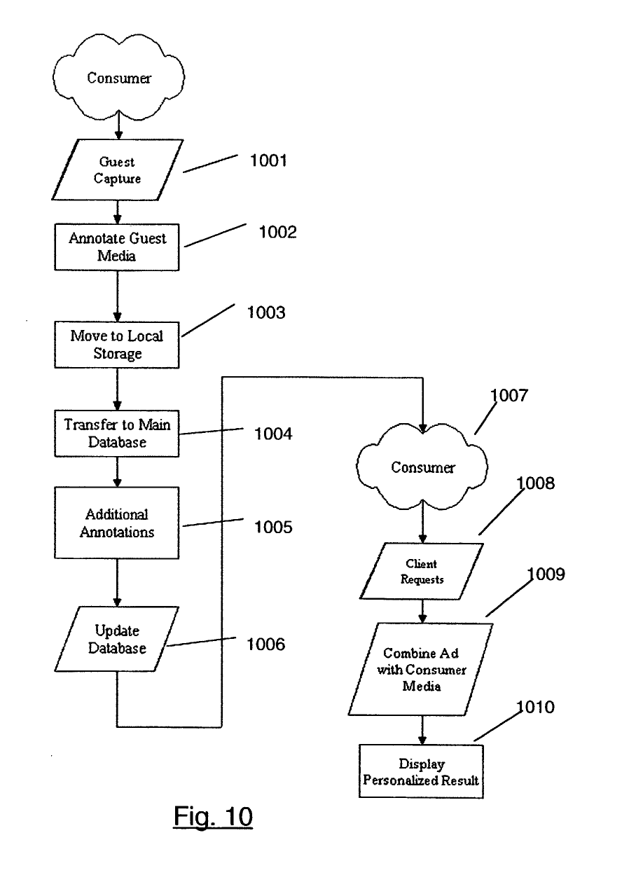

Referring to FIG. 10, the invention is further detailed. The process of capturing the user's video, stills, and/or audio is performed 1001. Any metadata is added to the user's material 1002 and stored locally in the movie booth 1003. The users material is then transferred to the processing server 1004, if one exists, with any additional information added to it 1005 and updated in the database 1006. The consumer then sees the potential ads 1007 and selects the desired ad 1008.

### Delivery of Customized/Personalized Media Products

### Display of Video, Stills, and/or Audio with Appropriate Advertisement

The video, stills, and/or audio are then combined with an existing media template 1009. This template consists of pre-existing video, stills, audio, graphics, and/or animation. The captured guest video, stills, and/or audio are then combined with the template video, stills, audio, graphics, and/or animation through compositing, insertion, or other techniques of combination. The combined result is then shown as an advertisement or combined with existing merchandise 1010. Illustrative examples include:

The creation of a personalized 7

Up commercial which can be delivered over the Web and/or other media delivery systems such as digital television. The guest footage is analyzed for the appropriate shots, such as looking at the camera and screaming. The combined video is then delivered to the consumer and/or their friends and family.

The creation of a personalized Gap banner ad or Flash animation for Web delivery. The guest footage is analyzed for the appropriate shots, such as a head turn and dancing. The combined animated ad is then delivered to the consumer and/or their friends and family.

The creation of a personalized movie trailer for a VHS or DVD (or other) retail product such as Gone With the Wind. The guest footage is analyzed for an appropriate sequence that would allow a man to stand at the bottom of a stairway looking at Scarlett or a woman, looking at Rhett. This guest footage is then combined with the original footage with the original actor removed. The combined product is then recorded onto a copy of Gone With the Wind as a personalized trailer.

The creation of a personalized book jacket for Harry Potter, in which the customer is composited with the main characters from the novel. The combined image is then printed on the cover of a pre-existing copy of Harry Potter with the original cover left suitably blank until the final addition of the personalized cover.

### Automatic Combination of Video, Stills, and/or Audio with Physical Media

The video, stills, and/or audio can also be automatically combined with physical media, such as T-shirts, mugs, etc. Using the process describe above, guest video, stills, and/or audio can be generated in the form of a storyboard to be put on T-shirts, posters, mugs, etc.

### Personalized Banner Ads and Other Advertising Forms

The invention's dynamic personalized banner ads and other advertising forms automatically incorporate images and/or sounds of consumers into an adaptive template.

1. Humans create a template banner ad or other advertising forms with empty slots for inserting video footage, frames, and or audio of individual consumers.

2. System assembles personalized banner ad or other advertising forms based on a) the identity of the individual(s) currently viewing the Web site, and b) a match between that individual(s) and stored video footage of the individual(s) in system's database. The invention can personalize using footage of the consumer's friends rather than just of the consumer and can personalize to groups who are online simultaneously or asynchronously.

3. System displays personalized banner ad or other advertising forms to consumer(s).

4. System can also be extended to be media rich: assembling ads that include images, sound, video, interaction scripts, etc.

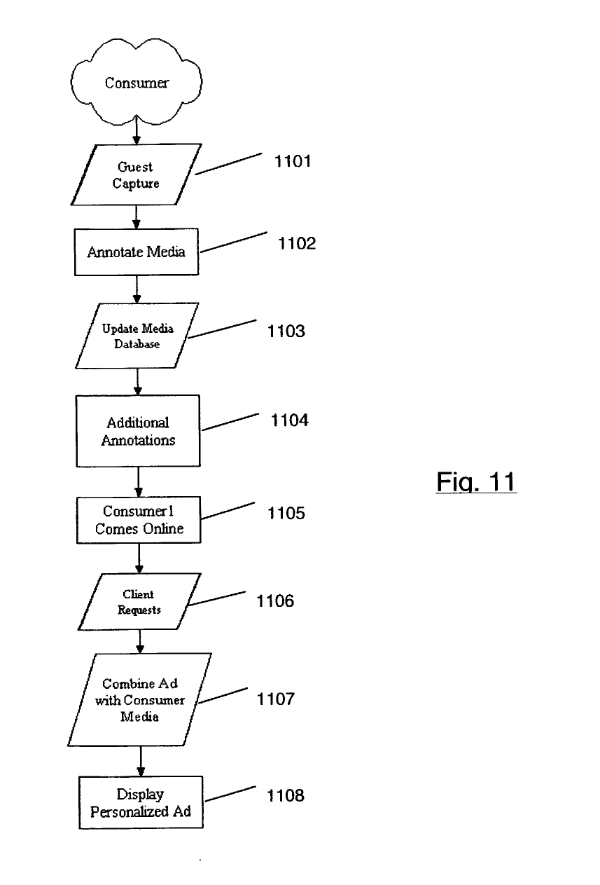

With respect to FIG. 11, the invention captures the user's elicited performance 1101. The user's personal information is added as metadata to the user's video, stills, and/or audio 1102 and stored in the database 1103. Any additional data is then added 1104.

The user either requests a specific ad, as described above, or goes online 1105, 1106. User or system requests specify the desired media, e.g., T-shirts, posters, videos, books, etc., to be personalized 1107 and delivered to the user 1108. Going online results in the automatic combination of the user's video, stills, and/or audio into targeted ads, e.g., banner ads, selected by the system 1107 and displayed to the user 1108.

### Automatic Personalized Media Products

A preferred embodiment of the invention automatically creates personalized media products such as: personalized videos, stills, audio, graphics, and animations; personalized dynamic images for inclusion in dynamic image products; personalized banner ads and other Internet advertising forms; personalized photo stickers including composited images as well as frame sequences from a video; and a wide range of personalized physical merchandise.

### Personalized Dynamic Images

Dynamic image technology allows multiple frames to be stored on a single printed card. Frames can be viewed by changing the angle of the card relative to the viewer's line of sight. Existing dynamic image products store some duration of video, by subsampling the video.

The invention allows the creation of a dynamic image product by automatically choosing frames and sequences of frames based on content. This imagery and/or video is then combined with an existing template. The template consists of pre-existing imagery and/or video. The captured user imagery and/or video is then combined with the template imagery and/or video either through compositing and/or insertion.

1. System analyzes the user performance.

2. System chooses frames based on the content of the video.

3. System combines chosen frames with template frames.

4. System generates combined entire image sequence.

5. System outputs combined entire image sequence to dynamic image.

### Automatic Personalized Media Identification

Today there are messaging services that allow users to see when their friends are online and to make their own online presence known to others. Messaging systems today provide minimal ability for identifying individual users. Typically, information about other users of a messaging system is in the form of text (names) or icons. The invention provides a system that allows for greater variety in the display of identifying information and also allows individual users to represent themselves to other users.

This invention automatically generates visual and/or auditory user IDs for messaging services. The video, stills, and/or audio representation of the user is displayed when a) a non real-time message from the user is displayed, as in email or message boards, or b) when the user is logged into a real time communications system as in chat, MUDs, or ICQ.

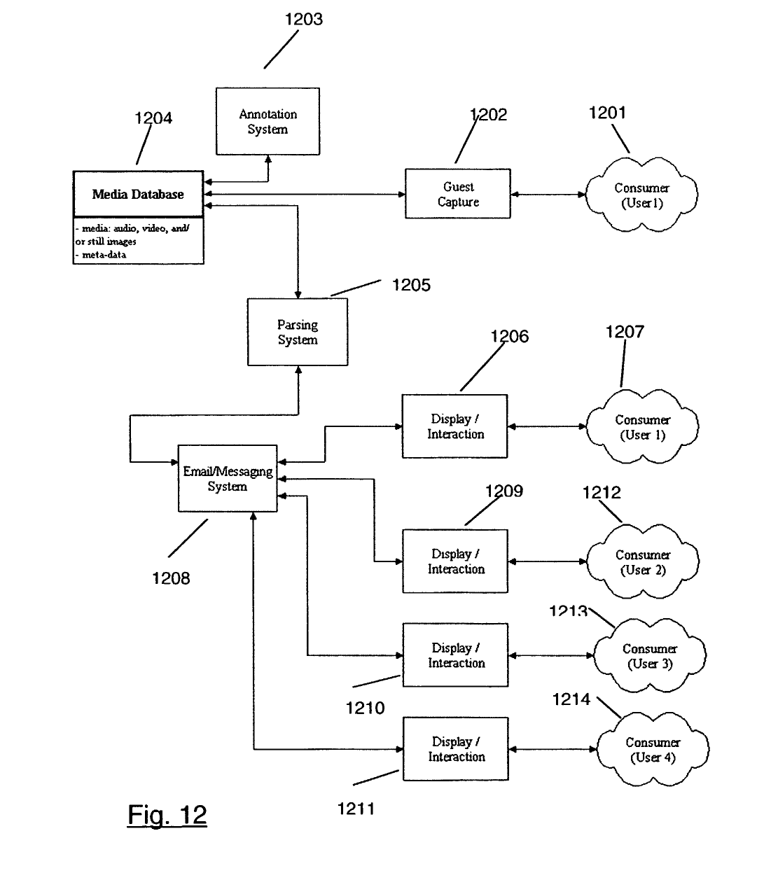

Referring to FIG. 12, the invention captures 1202 the user's 1201 video, stills, and/or audio representation. The video, stills, and/or audio ID representations are stored in the database 1204. Any additional metadata is added 1203.

The system then parses 1205 the captured video, stills, and/or audio to create a, or a set of, representation(s) of the user 1207 which are stored in the database 1204 and indexed to the user 1207. Examples include: a still of the user smiling; a video of the user waving; or audio and/or video of the user saying their name.

The user 1207 communicates online 1206 through an email/messaging system 1208, sending emails and/or chatting with other users. Whenever another user 1212, 1213, 1214 receives an email or message from the user 1207, the email/messaging system 1208 goes to the parsing system 1205 to retrieve the user's ID representation stored in the database 1204. There may be different ID representations depending on the communication, e.g., still picture for email, video for chat.

When the user's ID is called for in an email, newsgroup, or chat system, the representation is accessed from the database of parsed representations 1204. The advantage of keeping around the original captures is that new personal IDs can be created by parsing the captures again. For example, the parser 1205 looks not only for smiles but for smiles in which the eyes are most wide open, i.e., maximum white area around the pupils. The parser 1205 parses through the user's stored captures to automatically generate a new wide-eyed smiling personalized visual ID. Each request for a personalized ID does not always have to use the parser, only when first creating or creating a new and improved automatic personalized ID.

The user's ID representation is displayed to the other users 1212, 1213, 1214 when they read 1209, 1210, 1211 the user's 1207 messages through the email/messaging system 1208.

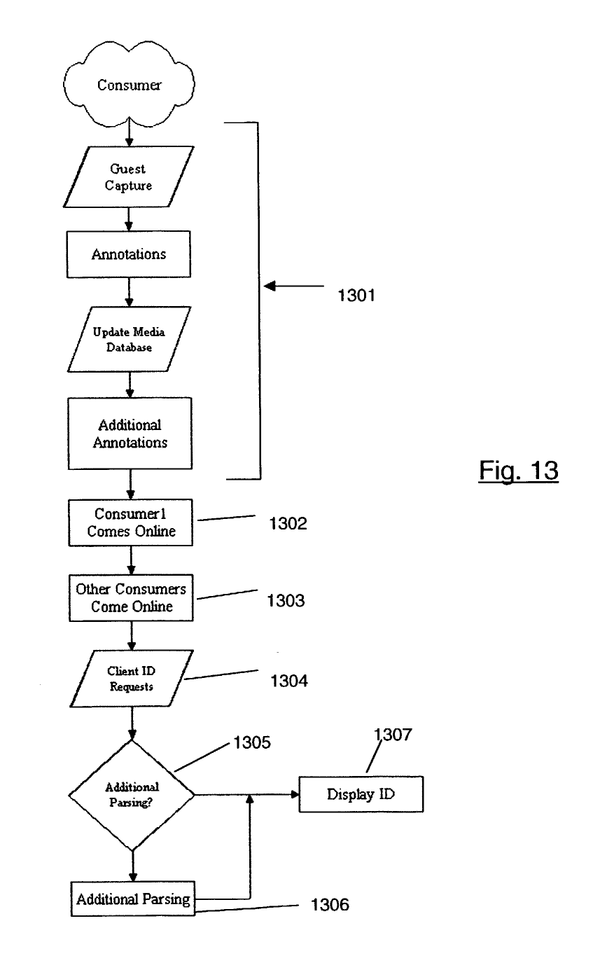

With respect to FIG. 13, the invention performs the performance elicitation, capture, and storage 1301. The user goes online 1302 and other users are online 1303. The other users open the user's email or read the user's messages 1304. The user's ID representation is retrieved, selected 1305, 1306 and then displayed to the other users 1307.

### Secure URL Forwarding

The invention also provides a uniform resource locator (URL) security mechanism. One often has the need to send a reference to a resource on a Web site to other parties. A URL provides a mechanism for representing this reference. The URL acts as a digital key for accessing the Web resource. Typically, a URL maps directly to a resource on the server. The invention provides for the generation of a dynamic URL that aids in the tracking and access control for the underlying resource. This dynamic URL encodes:

a) Information about the user wishing to transmit the URL.

b) The underlying resource referenced.

c) The desired target user or users.

d) A set of privileges or permissions the user wishes to grant the target user(s).

The dynamic URL can be transferred by any number of methods (digital or otherwise) to any number of parties, some of whom may not or cannot be known beforehand. It is very easy to forward the URL to additional parties, e.g., through email, once it is in digital form. Access to the dynamic URL can be tracked, and/or possibly restricted. Another benefit of this approach is the ability to track who originally distributed the reference to the resource.

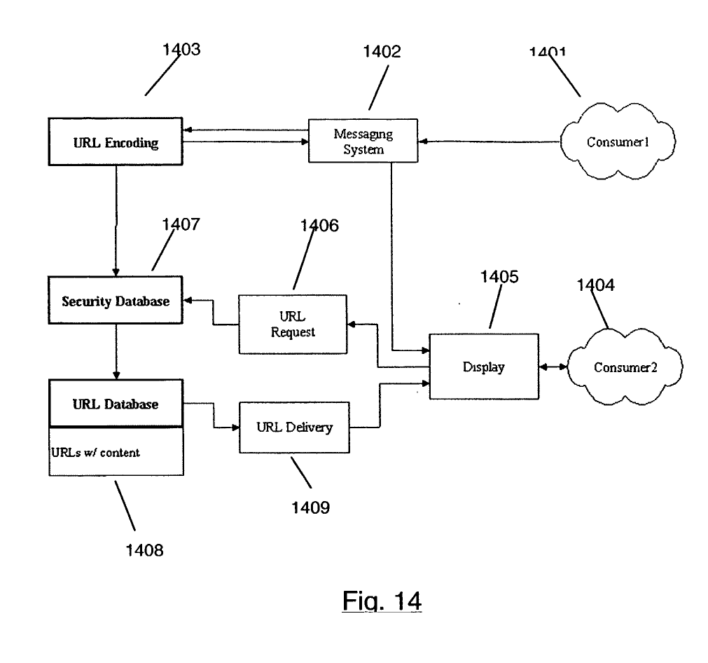

Referring to FIG. 14, a preferred embodiment of the invention ensures that one and only one recipient per target URL is allowed access to the resource.

1. System encodes 1403 each URL uniquely in a target 1401 specific manner (possibly derived from the target's email address).

2. URL is sent to a receiver 1404 via email or other messaging protocol 1402

a. Recipient 1404 attempts to connect to server using URL 1406.

b. [optional] Recipient is authenticated (asks for user's email address/password).

3. If URL has not been accessed before 1407 or it has been accessed b y fewer than maximum number of allowed recipients, the server stores a unique cookie or any persistent identification mechanism on the client's machine 1404, for example, the processor serial number, and indexes 1408 the cookie value with the URL 1409.

4. If URL has been accessed by the maximum number of recipients 1407 (in many cases, one), the connection will only succeed if an indexed cookie or any persistent identification mechanism on the client's machine 1404, for example, the processor serial number, is present and/or authentication succeeds.

Another embodiment of the invention ensures that only a fixed number of recipients per target URL are allowed access to the resource. Ensuring that the resource is accessible by only a fixed number of recipients may be sufficient security in some cases. If not, the authentication can be made further secure by querying the target recipient for information he/she is likely to know, such as his/her name.

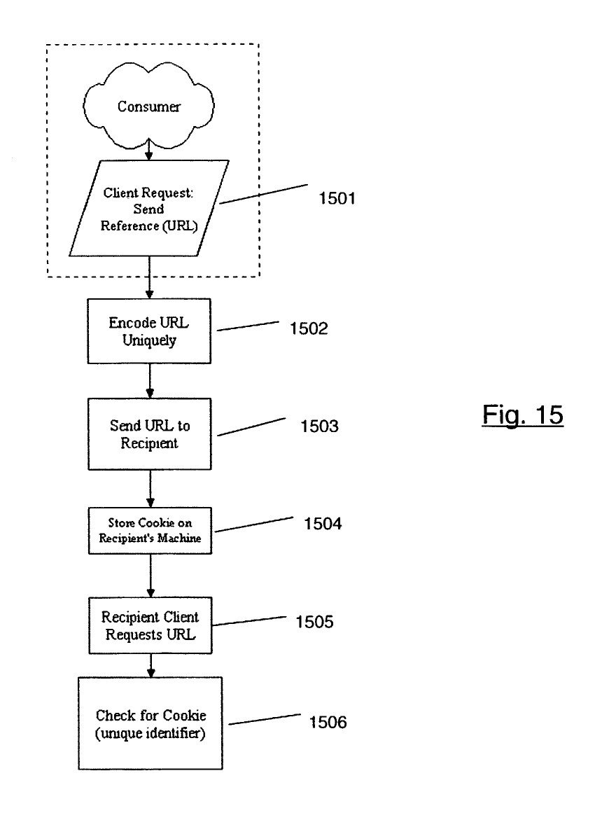

With respect to FIG. 15, a typical sequence of events is shown:

1. User requests to forward a link to a resource on the Web server to a target email address or set of addresses 1501.

2. User specifies a set of privileges to be granted to the target users, or a default set of privileges is used 1502.

3. Server creates a meta-record on the server 1502, storing the user, Web resource, target user(s), and usage privileges for both the resource and the meta-record. For example, the meta-record may specify that the target user may stream the underlying Web video resource, but not download it. The meta-record may be valid for only a certain period of time, or for a certain number of uses, after which all existing privileges are revoked and/or new grants denied. Even if the target user is unspecified, the user may still wish, possibly even more so than with specified users, to control the lifetime of the meta-record, whether in elapsed time or uses.

4. Server creates a URL which references the meta-record 1502. The URL may be partially or entirely random, and may potentially encode some or all of the information stored in the meta-record. For example, a URL which visibly shows a reference to the originating user makes clear to the user and target that the system can track from where the request originated.

5. Server sends email to the target email address(es) 1503 containing the dynamic URL, an automatically generated message describing its use, as well as whatever custom message the user may have requested to send.

6. When the server receives an HTTP request for the dynamic URL 1505, it verifies that the URL is still valid, i.e., it has not expired because of time or unique accesses.

7. If the URL is still valid, the server checks to see if the request is from an authenticated user. A user is authenticated if the request includes a cookie 1506 previously set by the server 1504. If the user is authenticated, the server verifies that the user is in the set of target users and, if so, it updates access statistics for the meta-record and underlying resources and grants the user whatever privileges are specified by the meta-record.

8. If the user is not authenticated, the server checks to see if anonymous or unspecified users are allowed access to the meta-record. If anonymous users are not allowed, then the server must forward the unauthenticated user to a login or registration page. If anonymous or unspecified users are allowed, the server has two options. Either the user can be assigned a temporary ID and user account, or the server can forward the user to a registration page, requiring him or her to create a new account. Once the user has an ID, it can be stored persistently on his or her machine with a cookie 1504, so subsequent accesses from the same machine can be tracked. The server then updates tracking info for the meta-record and grants the user whatever privileges are specified by the meta-record.

### Example Use Case Scenario

Joe Smith, member of amova.com, wishes to forward a link to his streaming video clip (hosted at amova.com) to friend Jim Brown, who has never been to amova.com. Due to its personal nature, Joe does not want Jim Brown to be able to forward the link to anyone else. Joe dicks on “forward link for viewing, exclusive use”, and enters jim brown@aol.com as the target user. Jim receives an email, explaining he's been invited to view a video clip of his friend Joe at amova.com, at a cryptic URL which he can click on or type into his browser.

### Viral Marketing Mechanisms and Metrics

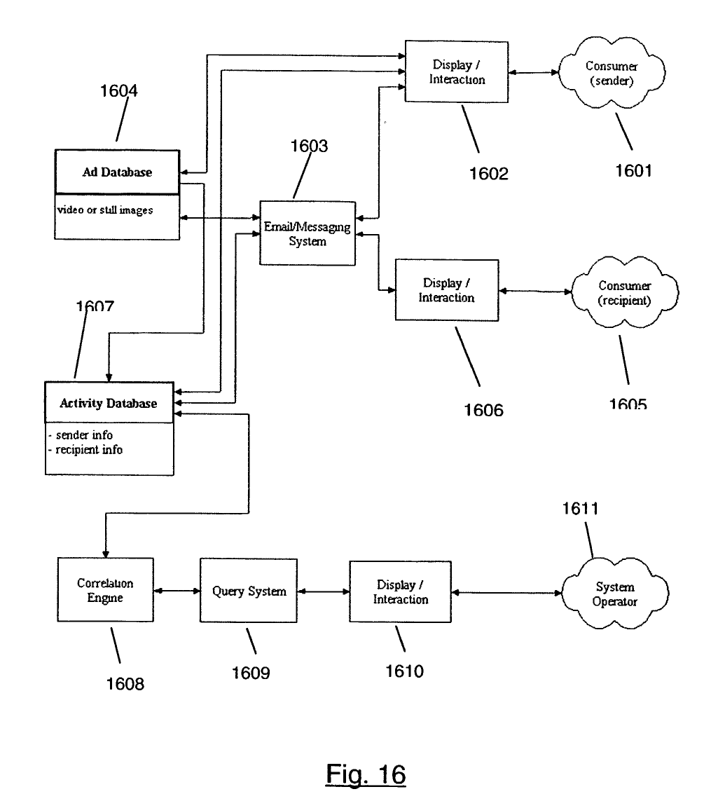

Referring to FIG. 16, a preferred embodiment of the invention provides a new and improved process for tracking consumer viewership of advertising and marketing materials. The invention also tracks other metadata, e.g., known information about senders, recipients, and time of day, time of year, content sent, etc. The invention uses:

a) A database of advertisements 1604.

b) Display of advertisements for consumer 1602.

c) A mechanism that allows consumers to send the advertisements or links to them 1603.

d) Display of advertisements for recipient(s) 1606.

e) Information about senders and/or receivers 1607.

f) A mechanism for tracking advertisements sent 1607 (as well as any responses).

g) An “engine” for correlating various kinds of metadata 1608 (demographics, etc.).

### Database of Advertisements

The advertisements (text, graphics, animation, video, still, or audio) reside in a database 1604 from which they can be retrieved and displayed on computer or TV screens or other display devices for consumers.

### Mechanism for Sending Advertisements or Links to Advertisements

The invention allows consumers to indicate their interest in sending the advertisement to someone, for example, a friend. In the case where the advertisement appears in a computer browser the consumer clicks on the ad and an unaddressed email message appears that includes a link to the ad. The user then enters the recipient's address and sends the mail. Or the sender can select the recipient(s) from a list of recipients stored in the sender's address book. In another embodiment of the invention, the advertisement can be included in the email as an attachment. In the case where the recipient gets a link, clicking on the link sends a message to a server which then displays the advertisement.

### Information about Senders/Receivers

This invention assumes it is part of a system that includes information about users. Such a system could be a typical membership site that includes information about members' names, ages, gender, zip codes, preferences, consumption habits, and so on. For the purpose of providing advertisers information about the interest generated in different demographics by their ads, the invention monitors who sends the message, and to the extent that the system has information about the recipient, information about recipients.

As an example, the system tracks whether an advertisement was sent to more men or women. It could provide a profile of the interest level according to the age of the senders. If the advertisements were sent in the form of links, the system can also track, among other things, the frequency with which the advertisements are actually “opened” or viewed by recipients.

The system could also perform more complex correlations by, for example, determining how many individuals from a certain zip code forwarded advertisements with certain kinds of content.

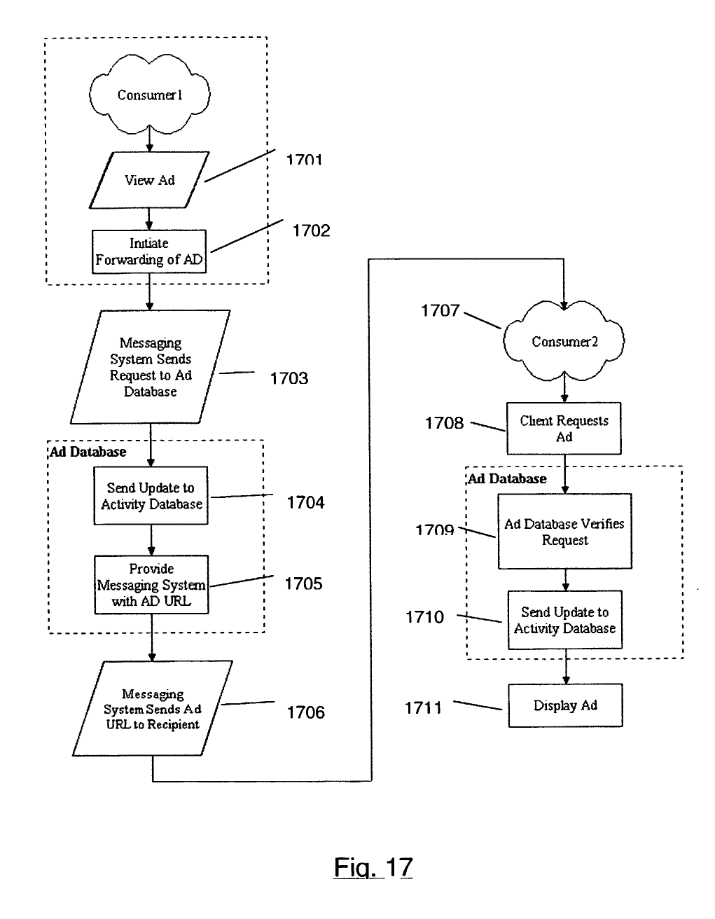

With respect to FIG. 17, the invention's consumer interaction and system operation are shown.

1. Consumer sees ads 1701.

2. Consumer selects ad for forwarding to someone else 1701.

3. Consumer types in email address of recipient 1702.

4. Consumer sends ad 1703.

5. Messaging system sends request for ad to ad database 1704.

6. Ad database gives activity database information about the ad, the sender, and recipients, if known 1705.

7. Ad database provides messaging system with URL to ad 1705.

8. Messaging system sends ad URL to recipients 1706.

9. Recipient receives ad 1707.

10. Recipient clicks on ad URL 1708.

11. Ad database verifies request 1709.

12. Ad database sends activity database recipient information 1710.

13. Recipient views ad 1711.

Referring again to FIG. 16, a typical operational scenario follows:

1. Web browser 1602 (consumer's client 1601) sends request to Ad Database for an ad 1604. The request includes a unique consumer ID and unique Ad ID.

2. Ad Database 1604 serves up ads in response to requests from clients Web Browser 1602.

3. Ad Database 1604 sends update to Activity Database 1607 with info about ID of individual, if known, requesting ad, Ad ID, and time of request.

4. System messaging 1603 starts on request from client.

5. “Create new email” template is generated at client request 1602.

6. Messaging system 1603 reads client request to “send mail with attachment.”

7. Messaging system 1603 resolves delivery address and includes (in message) a URL for attached advertisement from Ad Database 1604.

8. Messaging system 1603 sends update to Activity Database 1607 with info about sender ID, time messages was sent, and Ad ID.

9. Ad Database 1604 serves up ad in response to request generated by client 1605, e.g., human clicking on URL in email message.

10. Ad Database 1604 sends update to Activity Database 1607 with info about ID of individual, if known, requesting ad, Ad ID, and time of request.

11. System operator 1611 requests information regarding ad viewership 1609.

12. Correlation engine 1608 receives query and produces ad metrics corresponding to the query.

13. Ad metric information is displayed 1610 to the system operator 1611.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A process for automatically creating personalized media in a computer environment, comprising the steps of:
providing a capture area for a user;
eliciting a performance from the user;
capturing said performance; and
wherein said capture step records the video and/or audio of said performance using a video camera.

2. The process of claim 1, wherein said eliciting step elicits a performance from the user using audio and/or video cues.

3. The process of claim 1, further comprising the step of:
recognizing the presence of a user and/or a particular user and then interacting with the user to elicit a useable performance.

4. The process of claim 1, further comprising the step of:
automatically adjusting said video camera to the user's physical dimensions and position.

5. The process of claim 1, further comprising the step of:
analyzing said performance for acceptability; and
wherein the user is asked to re-perform the desired actions if said performance is unacceptable.

6. The process of claim 1, further comprising the steps of:
automatically compositing the desired footage of said performance into pre-recorded and/or dynamic media template footage; and
storing said composited footage for later delivery.

7. The process of claim 6, wherein the user selects said media template footage from a set of footage templates.

8. The process of claim 6, further comprising the step of:
providing an interactive display area outside of said capture area; and
wherein the user reviews said composited footage and specifies the delivery medium from said interactive display area.

9. The process of claim 1, further comprising the steps of:
automatically editing the desired footage of said performance into prerecorded or dynamic media template footage;
rendering said edited footage; and
storing said rendered footage for later delivery/distribution.

10. The process of claim 9, wherein the user selects said media template footage from a set of footage templates.

11. The process of claim 9, further comprising the step of:
providing an interactive display area outside of said capture area; and
wherein the user reviews said rendered footage and specifies the delivery medium from said interactive display area.

12. The process of claim 1, further comprising the steps of:
providing a network of capture areas;
wherein said capture areas are networked to a central data storage;
providing a network of processing servers;
providing a data management server; and
wherein said data management server maintains an index associating raw video data and user information.

13. The process of claim 12, further comprising the step of:
uploading video content to a central data storage and offsite Web/video hosting location; and
wherein raw video captures flow from said capture areas to said central data storage.

14. The process of claim 13, wherein said data management server manages the uploading of rendered and raw content to said Web/video host.

15. The process of claim 13, wherein said raw video captures are processed with select media templates by said processing servers to generate rendered movies.

16. The process of claim 15, wherein said rendered movies are stored and displayed to registration/viewing computers.

17. An apparatus for automatically creating personalized media in a computer environment, comprising:
a capture area for a user;
a module for eliciting a performance from the user;
a module for capturing said performance; and
wherein said capture module records the video and/or audio of said performance using a video camera.

18. The apparatus of claim 17, wherein said eliciting module elicits a performance from the user using audio and/or video cues.

19. The apparatus of claim 17, further comprising:
a module for recognizing the presence of a user and/or a particular user and then interacting with the user to elicit a useable performance.

20. The apparatus of claim 17, further comprising:
a module for automatically adjusting said video camera to the user's physical dimensions and position.

21. The apparatus of claim 17, further comprising:
a module for analyzing said performance for acceptability; and
wherein the user is asked to re-perform the desired actions if said performance is unacceptable.

22. The apparatus of claim 17, further comprising:
a module for automatically compositing the desired footage of said performance into pre-recorded and/or dynamic media template footage; and
a module for storing said composited footage for later delivery.

23. The apparatus of claim 22, wherein the user selects said media template footage from a set of footage templates.

24. The apparatus of claim 22, further comprising:
an interactive display area outside of said capture area; and
wherein the user reviews said composited footage and specifies the delivery medium from said interactive display area.

25. The apparatus of claim 17, further comprising:
a module for automatically editing the desired footage of said performance into pre-recorded and/or dynamic media template footage;
a module for rendering said edited footage; and
a module for storing said rendered footage for later delivery/distribution.

26. The apparatus of claim 25, wherein the user selects said media template footage from a set of footage templates.

27. The apparatus of claim 25, further comprising:
an interactive display area outside of said capture area; and
wherein the user reviews said rendered footage and specifies the delivery medium from said interactive display area.

28. The apparatus of claim 17, further comprising:
a network of capture areas;
wherein said capture areas are networked to a central data storage;
a network of processing servers;
a data management server; and
wherein said data management server maintains an index associating raw video data and user information.

29. The apparatus of claim 28, further comprising:
a module for uploading video content to a central data storage and offsite Web/video hosting location; and
wherein raw video captures flow from said capture areas to said central data storage.

30. The apparatus of claim 29, wherein said data management server manages the uploading of rendered and raw content to said Web/video host.

31. The apparatus of claim 29, wherein said raw video captures are processed with select media templates by said processing servers to generate rendered movies.

32. The apparatus of claim 31, wherein said rendered movies are stored and displayed to registration/viewing computers.

33. A process for automatically eliciting, recording, and processing a video or audio performance from a user in a computer environment, comprising the steps of:
eliciting a video and/or audio performance from the user;
wherein said eliciting step interacts with the user to elicit the desired video and/or audio output;
recording said performance;
analyzing said performance; and
storing said recording on a storage device for later retrieval.

34. The process of claim 33, wherein said analyzing step compares said performance with potential performances or criteria for a useable performance to determine whether further direction is needed or if the performance is acceptable.

35. The process of claim 34, wherein if further direction is required, the user is prompted to repeat the action.

36. The process of claim 33, wherein said eliciting step coaches the user for the proper performance.

37. The process of claim 33, wherein said eliciting, recording, and analyzing steps repeat until a usable performance is detected or a predetermined number of attempts have been reached; and wherein said storing step stores the best of the non-usable performances when said predetermined number of attempts have been reached or, in the case of deliberate user misbehavior, interaction with the user is discontinued.

38. The process of claim 33, wherein said recording step automatically adjusts the recording mechanism to the user's physical dimensions and position.

39. An apparatus for automatically eliciting, recording, and processing a video or audio performance from a user in a computer environment, comprising:
a module for eliciting a video and/or audio performance from the user;
wherein said eliciting module interacts with the user to elicit the desired video and/or audio output;
a module for recording said performance;
a module for analyzing said performance; and
a module for storing said recording on a storage device for later retrieval.

40. The apparatus of claim 39, wherein said analyzing module compares said performance with potential performances or criteria for a useable performance to determine whether further direction is needed or if the performance is acceptable.

41. The apparatus of claim 40, wherein if further direction is required, the user is prompted to repeat the action.

42. The apparatus of claim 39, wherein said eliciting module coaches the user for the proper performance.

43. The apparatus of claim 39, wherein said eliciting, recording, and analyzing modules repeat until a usable performance is detected or a predetermined number of attempts have been reached; and wherein said storing module stores the best of the non-usable performances when said predetermined number of attempts have been reached or, in the case of deliberate user misbehavior, interaction with the user is discontinued.

44. The apparatus of claim 39, wherein said recording module automatically adjusts the recording mechanism to the user's physical dimensions and position.

45. A process for automatically reframing and inserting a captured video of a user into a desired scene in a computer environment, comprising the steps of:
creating a model of the user in said captured video;
analyzing said video to find the eyes of the user;
extracting the foreground from said video; and
wherein said extracting step determines the boundaries of said foreground by approximating the user's head width and position.

46. The process of claim 45, further comprising the steps of:
providing a plurality of shot templates;
selecting a shot template; and
inserting said foreground into said shot template.

47. The process of claim 45, wherein said analyzing and extracting steps are repeated for each input frame in said video.

48. An apparatus for automatically reframing and inserting a captured video of a user into a desired scene in a computer environment, comprising:
a module for creating a model of the user in said captured video;
a module for analyzing said video to find the eyes of the user;
a module for extracting the foreground from said video; and
wherein said extracting module determines the boundaries of said foreground by approximating the user's head width and position.

49. The apparatus of claim 48, further comprising:
a plurality of shot templates;
a module for selecting a shot template; and
a module for inserting said foreground into said shot template.

50. The apparatus of claim 48, wherein said analyzing and extracting modules are repeated for each input frame in said video.

51. A process for automatically relighting captured video of a user to match a desired scene in a computer environment, comprising the steps of:
creating a reference light field model of the lighting in said captured video;
extracting the foreground of said captured video;
wherein said creating step extracts changes in light from the background of said captured video by identifying a region of interest with minimal object or camera motion and comparing consecutive frames; and
wherein each comparison generates a light field, which can be smoothed or modified based on the desired final scene lighting.

52. The process of claim 51, wherein the region of interest overlaps the final destination of the foreground.

53. The process of claim 51, further comprising the step of:
calculating an absolute notion of light by choosing a reference frame and region of interest in said destination video and comparing each frame of said captured video with the reference frame's region of interest.

54. The process of claim 51, wherein said smoothed light field is used as an additional layer on top of the foreground and background layers of the destination video for compositing.

55. The process of claim 51, wherein said light field is combined with the bottom layers of said destination video to simulate the application or removal of light.

56. An apparatus for automatically relighting captured video of a user to match a desired scene in a computer environment, comprising:
a module for creating a reference light field model of the lighting in said captured video;
a module for extracting the foreground of said captured video;
wherein said creating module extracts changes in light from the background of said captured video by identifying a region of interest with minimal object or camera motion and comparing consecutive frames; and
wherein each comparison generates a light field, which can be smoothed or modified based on the desired final scene lighting.

57. The apparatus of claim 56, wherein the region of interest overlaps the final destination of the foreground.

58. The apparatus of claim 56, further comprising;
a module for calculating an absolute notion of light by choosing a reference frame and region of interest in said destination video and comparing each frame of said captured video with the reference frame's region of interest.

59. The apparatus of claim 56, wherein said smoothed light field is used as an additional layer on top of the foreground and background layers of the destination video for compositing.

60. The apparatus of claim 56, wherein said light field is combined with the bottom layers of said destination video to simulate the application or removal of light.

61. A process for automatically transforming the motion path of a subject in a captured video to match the desired motion path of a target scene in a computer environment, comprising the steps of:
calculating said motion path of said subject;
wherein said calculating step automatically identifies and then tracks the position of a key feature of said subject in said captured video to derive said subject's motion path, such features include, but are not limited to: eye position, top of head, or center of mass;
transforming said motion path of said subject to match said desired motion path;
extracting said subject from said captured video;
applying said transformed motion path to said subject; and
inserting said transformed subject into said desired scene.

62. An apparatus for automatically transforming the motion path of a subject in a captured video to match the desired motion path of a target scene in a computer environment, comprising:
a module for calculating said motion path of said subject;
wherein said calculating module automatically identifies and then tracks the position of a key feature of said subject in said captured video to derive said subject's motion path, such features include, but are not limited to: eye position, top of head, or center of mass;
a module for transforming said motion path of said subject to match said desired motion path;
a module for extracting said subject from said captured video;
a module for applying said transformed motion path to said subject; and
a module for inserting said transformed subject into said desired scene.

63. A process for automatically transforming the motion path of a subject in a captured video to match a desired motion path of a target scene in a computer environment, comprising the steps of:
calculating said motion path of said subject;
wherein said calculating step automatically identifies and then tracks the position of a key feature of said subject in said captured video to derive said subject's motion path, such features include, but are not limited to: eye position, top of head, or center of mass;
transforming said motion path of said subject to match said desired motion path; and
applying said transformed motion path to transform the motion path of a desired element in, or elements in, or the entire, target scene.

64. An apparatus for automatically transforming the motion path of a subject in a captured video to match a desired motion path of a target scene in a computer environment, comprising:
a module for calculating said motion path of said subject;
wherein said calculating module automatically identifies and then tracks the position of a key feature of said subject in said captured video to derive said subject's motion path, such features include, but are not limited to: eye position, top of head, or center of mass;
a module for transforming said motion path of said subject to match said desired motion path; and
a module for applying said transformed motion path to transform the motion path of a desired element in, or elements in, or the entire, target scene.

65. A process for automatically transforming the motion path of a subject in a captured video to match the desired motion path of a target scene in a computer environment, comprising the steps of:
calculating said motion path of said subject;
wherein said calculating step automatically identifies and then tracks the position of a key feature of said subject in said captured video to derive said subject's motion path, such features include, but are not limited to: eye position, top of head, or center of mass;
transforming said motion path of said subject to match said desired motion path; and
co-modifying the motion path of said subject and the motion path of a desired element in, or elements in, or the entire, target scene using said transformed motion path.

66. An apparatus for automatically transforming the motion path of a subject in a captured video to match the desired motion path of a target scene in a computer environment, comprising:
a module for calculating said motion path of said subject;
wherein said calculating module automatically identifies and then tracks the position of a key feature of said subject in said captured video to derive said subject's motion path, such features include, but are not limited to: eye position, top of head, or center of mass;
a module for transforming said motion path of said subject to match said desired motion path; and
a module for co-modifying the motion path of said subject and the motion path of a desired element in, or elements in, or the entire, target scene using said transformed motion path.

67. A method for automatically reusing captured video, stills, and/or audio for personalized media, advertising, direct marketing, and/or merchandise in a computer environment, comprising the steps of:
automatically capturing video, stills, and/or audio of consumers, their friends, and family;
reusing said captured video, stills, and/or audio for the delivery of personalized media, advertising, direct marketing, and/or merchandise over any delivery medium.

68. The method of claim 67, further comprising the step of:
obtaining the consumer's personal information, including, but not limited to:
name, age, gender, email, address.

69. The method of claim 68, wherein said reusing step specifically targets personalized media, advertising, and direct marketing using said consumer's personal information.

70. A process for automatically creating personalized media and advertising using captured video, stills, and/or audio of consumers in a computer environment, comprising the steps of:
capturing video, stills, and/or audio of the consumer;
extracting the consumer's image from said captured video, stills, and/or audio;
providing a database of a collection of consumers' extracted video, stills, and/or audio that includes metadata about the video, stills, and/or audio; and
wherein said metadata includes, but is not limited to: the user's name, age, gender, email, and address.

71. The process of claim 70, wherein said metadata is gathered at the time of capture.

72. The process of claim 70, wherein said extracting step automatically analyzes and extracts a series of frames to provide a brief animation and/or video sequence.

73. The process of claim 70, wherein said extracting step extracts the desired content based on audio criteria matched to a target utterance.

74. The process of claim 70, wherein said extracting step extracts the desired content by parsing the user performance to select a desired combined audio/video utterance.

75. The process of claim 70, further comprising the steps of:
providing a plurality of media templates;
wherein said templates consist of pre-existing video, stills, audio, graphics, and/or animation;
combining the consumer's extracted video, stills, and/or audio with a media template; and
wherein the combined result is shown as an advertisement, entertainment, personal communication, promotion, direct marketing message, and/or combined with existing merchandise.

76. The process of claim 70, further comprising the steps of:
combining the consumer's extracted video, stills, and/or audio with physical media; and
delivering said physical media to the consumer.

77. The process of claim 70, further comprising the steps of:
providing a database of ads;
wherein the consumer browses through a list of ads in said ad database and selects the desired ad; and
combining the consumer's extracted video, stills, and/or audio with said desired ad to create a resulting ad.

78. The process of claim 77, further comprising the steps of:
displaying said resulting ad to the user; and
delivering said resulting ad to the consumer in the manner specified by the consumer.

79. The process of claim 70, further comprising the steps of:
creating a template banner ad or other advertising forms with empty slots for inserting video footage, frames, and or audio of individual consumers;
automatically assembling a personalized banner ad or other advertising forms;
wherein said personalized banner ad or other advertising forms is selected based on: a) the identity of the individual(s) currently viewing the Web site, and b) a match between that individual(s) and stored video footage of the individual(s) in said database; and
wherein said automatic assembling step combines said stored video footage with said personalized banner ad or other advertising forms.

80. The process of claim 79, wherein said automatic assembling step can personalize a banner ad or other advertising forms by using footage of the consumer's friends rather than just of the consumer, or footage of groups of people who are online simultaneously or asynchronously.

81. The process of claim 79, further comprising the step of:
displaying said personalized banner ad or other advertising forms to the consumer(s).

82. An apparatus for automatically creating personalized media and advertising using captured video, stills, and/or audio of consumers in a computer environment, comprising:
a module for capturing video, stills, and/or audio of the consumer;
a module for extracting the consumer's image from said captured video, stills, and/or audio;
a database of a collection of consumers' extracted video, stills, and/or audio that includes metadata about the video, stills, and/or audio; and
wherein said metadata includes, but is not limited to: the user's name, age, gender, email, and address.

83. The apparatus of claim 82, wherein said metadata is gathered at the time of capture.

84. The apparatus of claim 82, wherein said extracting module automatically analyzes and extracts a series of frames to provide a brief animation and/or video sequence.

85. The apparatus of claim 82, wherein said extracting module extracts the desired content based on audio criteria matched to a target utterance.

86. The apparatus of claim 82, wherein said extracting module extracts the desired content by parsing the user performance to select a desired combined audio/video utterance.

87. The apparatus of claim 82, further comprising:
a plurality of media templates;
wherein said templates consist of pre-existing video, stills, audio, graphics, and/or animation;
a module for combining the consumer's extracted video, stills, and/or audio with a media template; and
wherein the combined result is shown as an advertisement, entertainment, personal communication, promotion, direct marketing message, and/or combined with existing merchandise.

88. The apparatus of claim 82, further comprising:
a module for combining the consumer's extracted video, stills, and/or audio with physical media; and
a module for delivering said physical media to the consumer.

89. The apparatus of claim 82, further comprising:
a database of ads;
wherein the consumer browses through a list of ads in said ad database and selects the desired ad; and
a module for combining the consumer's extracted video, stills, and/or audio with said desired ad to create a resulting ad.

90. The apparatus of claim 89, further comprising:
a module for displaying said resulting ad to the user; and
a module for delivering said resulting ad to the consumer in the manner specified by the consumer.

91. The apparatus of claim 82, further comprising:
a module for creating a template banner ad or other advertising forms with empty slots for inserting video footage, frames, and or audio of individual consumers;
a module for automatically assembling a personalized banner ad or other advertising forms;
wherein said personalized banner ad or other advertising forms is selected based on: a) the identity of the individual(s) currently viewing the Web site, and b) a match between that individual(s) and stored video footage of the individual(s) in said database; and
wherein said automatic assembling module combines said stored video footage with said personalized banner ad or other advertising forms.

92. The apparatus of claim 91, wherein said automatic assembling module can personalize a banner ad or other advertising forms by using footage of the consumer's friends rather than just of the consumer, or footage of groups of people who are online simultaneously or asynchronously.

93. The apparatus of claim 91, further comprising:
a module for displaying said personalized banner ad or other advertising forms to the consumer(s).

94. A process for automatically creating and retrieving an electronic personalized media identification using captured video, stills, and/or audio of a user in a computer environment, comprising the steps of:
capturing the user's video, stills, and/or audio representation;
creating a visual and/or audio user ID;
wherein said creating step parses said captured video, stills, and/or audio to create a, or a set of, representation(s) of the user;
providing a database containing users' video, stills, and/or audio ID representations; and
storing said user ID in said database.

95. The process of claim 94, further comprising the steps of:
retrieving and selecting the appropriate user's ID from said database when the user's ID is called for in an email, newsgroup, or chat system; and
displaying said appropriate user's ID in said email, newsgroup, or chat system.

96. An apparatus for automatically creating and retrieving an electronic personalized media identification using captured video, stills, and/or audio of a user in a computer environment, comprising:
a module for capturing the user's video, stills, and/or audio representation;
a module for creating a visual and/or audio user ID;
wherein said creating step parses said captured video, stills, and/or audio to create a, or a set of, representation(s) of the user;
a database containing users' video, stills, and/or audio ID representations; and
a module for storing said user ID in said database.

97. The apparatus of claim 96, further comprising:
a module for retrieving and selecting the appropriate user's ID from said database when the user's ID is called for in an email, newsgroup, or chat system; and
a module for displaying said appropriate user's ID in said email, newsgroup, or chat system.

98. A process for creating a secure, dynamic uniform resource locator (URL) in a computer environment, comprising the steps of:
creating a meta-record for a specific resource;
wherein said creating step stores information that includes, but is not limited to: the user, the identifier for said resource, target user(s), and usage privileges for both said resource and said meta-record in said meta-record;
encoding a dynamic URL which references said meta-record;
wherein said dynamic URL is partially or entirely random, and may encode some or all of the information stored in said meta-record;
transferring said dynamic URL to any number of recipients specified by the user via email or other messaging protocol;
authenticating a recipient upon receipt of an HTTP request for said dynamic URL; and
wherein said authentication step grants said recipient whatever privileges are specified in said meta-record upon successful authentication.

99. The process of claim 98, wherein said authenticating step verifies that said dynamic URL is still valid upon receipt of said HTTP request.

100. The process of claim 98, wherein the user specifies said usage privileges as a set of privileges to be granted to the target users, otherwise, a default set of privileges is used.

101. The process of claim 98, wherein said authentication step updates access statistics for said meta-record and any underlying resources upon successful authentication and access.

102. The process of claim 98, wherein the user specifies the maximum number of recipients allowed to access said dynamic URL.

103. The process of claim 102, wherein said authentication step stores a unique cookie or any persistent identification mechanism on said recipient's machine before allowing access to said dynamic URL if said dynamic URL is being accessed for the first time or has been accessed by fewer than said maximum number of recipients allowed.

104. The process of claim 103, wherein if said dynamic URL has been accessed by the maximum number of recipients, access to said dynamic URL will only succeed if said unique cookie or any persistent identification mechanism on said recipient's machine is present and/or a manual authentication process succeeds.

105. The process of claim 103, wherein said authentication step allows access to said resource if said unique cookie or any persistent identification mechanism is present on said recipient's machine.

106. The process of claim 98, wherein said authentication step makes the authentication further secure by querying said recipient for information he/she is likely to know.

107. The process of claim 98, wherein said authentication step allows access only to recipients in the list of target recipients specified by the user.

108. The process of claim 98, wherein said meta-record specifies that the target recipient may stream the underlying Web video resource, but not download it.

109. The process of claim 98, wherein said meta-record may be valid for only a certain period of time, or for a certain number of uses, after which all existing privileges are revoked and/or new grants denied.

110. The process of claim 98, wherein said authentication step, if anonymous or unspecified recipients are allowed, assigns a temporary ID and user account to said recipient or forwards said recipient to a registration page, requiring him or her to create a new account, before being granted access to said resource.

111. An apparatus for creating a secure, dynamic uniform resource locator (URL) in a computer environment, comprising:
a module for creating a meta-record for a specific resource;
wherein said creating module stores information that includes, but is not limited to: the user, the identifier for said resource, target user(s), and usage privileges for both said resource and said meta-record in said meta-record;
a module for encoding a dynamic URL which references said meta-record;
wherein said dynamic URL is partially or entirely random, and may encode some or all of the information stored in said meta-record;
a module for transferring said dynamic URL to any number of recipients specified by the user via email or other messaging protocol;
a module for authenticating a recipient upon receipt of an HTTP request for said dynamic URL; and
wherein said authentication module grants said recipient whatever privileges are specified in said meta-record upon successful authentication.

112. The apparatus of claim 111, wherein said authenticating module verifies that said dynamic URL is still valid upon receipt of said HTTP request.

113. The apparatus of claim 111, wherein the user specifies said usage privileges as a set of privileges to be granted to the target users, otherwise, a default set of privileges is used.

114. The apparatus of claim 111, wherein said authentication module updates access statistics for said meta-record and any underlying resources upon successful authentication and access.

115. The apparatus of claim 114, wherein the user specifies the maximum number of recipients allowed to access said dynamic URL.

116. The apparatus of claim 115, wherein said authentication module stores a unique cookie or any persistent identification mechanism on said recipient's machine before allowing access to said dynamic URL if said dynamic URL is being accessed for the first time or has been accessed by fewer than said maximum number of recipients allowed.

117. The apparatus of claim 116, wherein if said dynamic URL has been accessed by the maximum number of recipients, access to said dynamic URL will only succeed if said unique cookie or any persistent identification mechanism on said recipient's machine is present and/or a manual authentication process succeeds.

118. The apparatus of claim 116, wherein said authentication module allows access to said resource if said unique cookie or any persistent identification mechanism is present on said recipient's machine.

119. The apparatus of claim 111, wherein said authentication module makes the authentication further secure by querying said recipient for information he/she is likely to know.

120. The apparatus of claim 111, wherein said authentication module allows access only to recipients in the list of target recipients specified by the user.

121. The apparatus of claim 111, wherein said meta-record specifies that the target recipient may stream the underlying Web video resource, but not download it.

122. The apparatus of claim 111, wherein said meta-record may be valid for only a certain period of time, or for a certain number of uses, after which all existing privileges are revoked and/or new grants denied.

123. The apparatus of claim 111, wherein said authentication module, if anonymous or unspecified recipients are allowed, assigns a temporary ID and user account to said recipient or forwards said recipient to a registration page, requiring him or her to create a new account, before being granted access to said resource.

124. A process for tracking consumer viewership of advertising and marketing materials in a computer environment, comprising the steps of:
providing a database of advertisements;
displaying a selection of ads from said database of advertisements to the user;
forwarding an ad to any number of recipients specified by the user;
wherein said ad is selected by the user from said database of advertisements;
receiving a request for said ad from a recipient; and
sending a uniform resource locator (URL) pointer to said ad to said recipient.

125. The process of claim 124, wherein said request includes a unique consumer ID and unique ad ID.

126. The process of claim 124, further comprising the step of:
providing an ad activity database.

127. The process of claim 126, wherein said displaying step, for each ad displayed, updates said activity database with information, including, but not limited to: the ID of the user, requesting ad, ad ID, and time of request.

128. The process of claim 126, wherein said forwarding step updates said activity database with information, including, but not limited to: the sender ID, time message was sent, and ad ID.

129. The process of claim 126, wherein said receiving step updates said activity database with information, including, but not limited to: the recipient ID, requesting ad, ad ID, and time of request.

130. The process of claim 126, further comprising the step of:
compiling and displaying information regarding ad viewership from said activity database to a system operator.

131. An apparatus for tracking consumer viewership of advertising and marketing materials in a computer environment, comprising:
a database of advertisements;
a module for displaying a selection of ads from said database of advertisements to the user;
a module for forwarding an ad to any number of recipients specified b y the user;
wherein said ad is selected by the user from said database of advertisements;
a module for receiving a request for said ad from a recipient; and
a module for sending a uniform resource locator (URL) pointer to said ad to said recipient.

132. The apparatus of claim 131, wherein said request includes a unique consumer ID and unique ad ID.

133. The apparatus of claim 131, further comprising:
an ad activity database.

134. The apparatus of claim 133, wherein said displaying module, for each ad displayed, updates said activity database with information, including, but not limited to: the ID of the user, requesting ad, ad ID, and time of request.

135. The apparatus of claim 133, wherein said forwarding module updates said activity database with information, including, but not limited to: the sender ID, time message was sent, and ad ID.

136. The apparatus of claim 133, wherein said receiving module updates said activity database with information, including, but not limited to: the recipient ID, requesting ad, ad ID, and time of request.

137. The apparatus of claim 133, further comprising:
a module for compiling and displaying information regarding ad viewership from said activity database to a system operator.
